(19) United States
(12) Patent Application Publication
(10) Pub. No.: US 2014/0208545 A1
(43) Pub. Date: Jul. 31, 2014

(54) RAIL AND ROLLER OF A WINDOW AND DOOR SYSTEM AND WINDOW OPERATION APPARATUS FOR WINDOWS AND DOORS USING SAME

(71) Applicant: Hyuk Soo Jang, Seongnam-si (KR)

(72) Inventor: Hyuk Soo Jang, Seongnam-si (KR)

(21) Appl. No.: 14/342,329

(22) PCT Filed: May 2, 2012
(86) PCT No.: PCT/KR2012/003447

§ 371 Date: Feb. 28, 2014

(30) Foreign Application Priority Data
Aug. 31, 2011 (KR) 10-2011-0087789

(51) Int. Cl. E05D 15/16; E06B 3/44

(52) U.S. Cl. CPC E05D 15/165; E06B 3/44
USPC 16/96 R; 16/107

(57) ABSTRACT

The present invention relates to a rail and a door roller of a window and door system and a window operation apparatus for windows and doors using the same. The rail and the door roller of a window and door system and the window operation apparatus for windows and doors using the same according to the present invention include: one or more upper linear rail units 1 which are installed on an upper end of a window casing, are opened downward so as to rectilinearly guide a door roller 3 that is installed on an upper end of a window frame and has a vertical shaft 3a or a diagonal shaft 3b, have guides 4 that are vertically or diagonally formed at both sides thereof, and are rectilinearly formed to have a predetermined length; and one or more upper meandering rail units 2 which diagonally or curvedly guide an upper door roller 3, which rectilinearly moves on the upper linear rail unit 1, so as to operate the window frame in a horizontal direction, are installed to be connected to one side end of the upper linear rail unit 1 so as to be connected to the guides 4 of the upper linear rail unit 1 with the same cross section, and have guides 4 that are diagonally or curvedly extended.

### TECHNICAL FIELD

The present invention relates to a rail and a roller of a window and door system and a window operation apparatus for windows and doors using the same, and more particularly, to a rail and a roller of a window and door system and a window operation apparatus for windows and doors using the same, which allow a sliding type window or door to freely move when the door or the window moves, and operate the window or the door so that the window or the door comes into contact with a window casing when the door or the window is closed.

### BACKGROUND ART

In general, windows and doors have a configuration in which a door or a window is opened and closed at a door frame or a window casing by being laterally pushed, and a door roller unit is provided at one side of the door or the window.

A load of the door or the window is applied to the door roller unit, and thus, there is a requirement that the door or the window needs to smoothly move while supporting the load of the door or the window.

When describing a configuration and an operation of the door roller unit in the related art, an axis of a wheel, which is provided in the door roller unit so as to come into rolling contact with an upper surface of a rail formed on a door frame or a window casing, is disposed in a horizontal direction, and as a result, there is a structural characteristic in which a height (size) of the door roller unit is increased.

Therefore, in the window and door system having the door roller unit in the related art, an excessive amount of materials is consumed for use thereof, which are required to secure substantial functions of windows and doors, and needed, and the door roller unit in the related art directly causes problems such as deterioration in thermal insulation effect and wind prevention effect.

For example, when describing the related art in terms of a consumption amount of materials, a rotation axis of the wheel of the door roller unit is disposed in a horizontal direction, and thus, a size of the door roller unit in a height direction of the wheel is increased, and a shield portion needs to be enlarged in the height direction in order to shield the door roller unit from the outside.

In addition, in order to prevent deviation between the door or the window and the rail, a skirt is formed by extending the shield portion of the door roller unit so that the door or the window may enclose parts of both ends of side surfaces of the rail, and therefore, there is a problem in that a required amount of materials is increased.

In addition, when the door roller unit is installed in the door or the window, both side spaces are formed in the door roller unit, these spaces are communicated with the outside, and thus, there are problems in that effects of heat insulation, thermal insulation, wind prevention, sound prevention, and the like deteriorate.

In addition, when a large-scale door or window is provided, a load of the door or window is increased, a door roller unit having higher durability is required, and consequently, there are problems in that a diameter of the wheel of the door roller unit is made larger, and an amount of materials used thereof, which is required to shield the door roller unit, is further increased as much as the space occupied by the door roller unit.

Meanwhile, in order to increase effects of preventing sound and wind in the window and door system, a technology, which operates the door or the window so that the door or the window comes into close contact with a door frame or a window casing in a state in which the door or the window is closed, is suggested.

In this case, as a size of the wheel of the door roller unit is increased in the height direction, the shield portion is enlarged overall, and particularly, widened in a meeting direction, and as the shield portion is widened, the rail is also widened in order to secure portions where the rail and the door or the window overlap, and as a result, there is a problem in that a consumption amount of materials, which constitute the door frame or the window casing, is increased.

On the other hand, the door or the window needs to be operated in left and right directions so as to come into close contact with the door frame or the window casing in a state in which the door or the window is closed, but there is a problem in that the operation of the door or the window in the left and right directions is limited by the aforementioned configuration of the door roller unit in which the rotation axis is disposed in the horizontal direction.

That is, the skirt, which is formed to shield the door roller unit, or prevent the door or the window from being moved away from the rail of the door frame or the window casing, is formed regardless of basic wind prevention performance of the window and door system, and has problems that rather degrades effects of preventing wind and sound, and increases a consumption amount of materials.

### DISCLOSURE

### Technical Problem

Therefore, a technical object to be achieved in the present invention is to provide upper and lower rails and a door roller of a window and door system, and a window operation apparatus using the same, which enables a meandering movement according to a linear movement and an operation in left and right directions of a door or a window, such that the movement of the door or the window is not hindered when the door or the window is opened and closed, and the door or the window and a door frame or a window casing come into close contact with each other when the door or the window is closed.

Another object of the present invention is to provide upper and lower rails and a door roller of a window and door system, and a window operation apparatus using the same, which may reduce a height of a door roller unit, which is provided to allow a door or a window to slide, thereby remarkably reducing a consumption amount of materials that are required to shield the door roller unit.

Yet another object of the present invention is to provide upper and lower rails and a door roller of a window and door system, and a window operation apparatus using the same, which may secure a distance at which a door or a window may be operated when the door or the window is closed, such that a degree of close contact between the door or the window and a door frame or a window casing may be improved, thereby improving effects of preventing wind and sound.

Still another object of the present invention is to provide various shapes of rolling wheels of door rollers, and rails that match the various shapes.

In addition, still yet another object of the present invention is to allow a rail unit and a door roller unit to be applied to all of opening and closing doors, collapsible doors, hanger type doors, windows, fixed windows, and hinged doors or windows, and to slide smoothly without being affected by a load of a door or a window.

### Technical Solution

The object is achieved by an upper rail unit of a window and door system, including: one or more upper linear rail units 1 which are installed on an upper end of a window casing, are opened downward so as to rectilinearly guide a door roller 3 that is installed on an upper end of a window frame and has a vertical shaft 3a or a diagonal shaft 3b, have guides 4 that are vertically or diagonally formed at both sides thereof, and are rectilinearly formed to have a predetermined length; and one or more upper meandering rail units 2 which diagonally or curvedly guide an upper door roller 3, which rectilinearly moves on the upper linear rail unit 1, so as to operate the window frame in a horizontal direction, are installed to be connected to one side end of the upper linear rail unit 1 so as to be connected to the guides 4 of the upper linear rail unit 1 with the same cross section, and have guides 4 that are diagonally or curvedly extended.

Here, it is preferable that the upper meandering rail unit 2 further includes a rectilinear portion at an end of the upper meandering rail unit 2 so that the upper door roller may also rectilinearly move at a predetermined distance after moving diagonally or curvedly.

Further, an interval between both the guides 4 of the meandering rail unit 2 is configured to have any one width among a predetermined narrow width, a predetermined wide width, and the same width so that the upper door roller 3 is guided based on a movement direction of the upper door roller 3

Meanwhile, the object is achieved by an upper rail unit of a window and door system, including: one or more upper linear rail units 1 which are installed on an upper end of a window casing, are opened downward so as to rectilinearly guide an upper door roller 3 that is installed on an upper end of a window frame, have guides 4 that are diagonally or rectilinearly formed at both sides thereof, and are rectilinearly formed to have a predetermined length; and an upper meandering rail unit 2 which diagonally or curvedly guides the upper door roller 3, which rectilinearly moves on the upper linear rail unit 1, so as to operate the window frame in a horizontal direction, is installed to be connected to one side end of the upper linear rail unit 1 so as to be connected to the upper linear rail unit 1 with the same cross section, and includes a plurality of protruding portions 13 that protrudes at a predetermined position of one side surface of any one of both the guides 4 so as to guide the upper door roller 3 toward the other side surface, and a groove portion 14 that is formed in an inner surface of the other guide 4 so that the upper door roller 3, which comes into rolling contact with the guide 4 and moves, is inserted into the groove portion 14 by the protruding portion 13 when the upper door roller 3 is guided toward the other side surface.

Meanwhile, the object is achieved by an upper rail unit of a window and door system, including: one or more linear rail units 1 which are installed on an upper end of a window casing, protrude downward so as to rectilinearly guide an upper door roller 3 that is installed on an upper end of a window frame, have guides 4 that are formed on both vertical side surfaces thereof so as to have contact points with the upper door roller and guide the upper door roller, and are rectilinearly formed to have a predetermined length; and an upper meandering rail unit 2 which is installed to be connected to the upper linear rail unit 1 so as to operate the window frame in a horizontal direction while diagonally or curvedly guiding the upper door roller 3 that comes into contact with both vertical side surfaces of the upper linear rail unit 1 and rectilinearly moves, has guides 4 that protrude downward and are formed on both vertical side surfaces so as to have contact points with the upper door roller 3 and guide the upper door roller 3, and is diagonally or curvedly extended.

Further, it is preferable that the upper meandering rail unit 2 further includes a rectilinear portion at an end of the upper meandering rail unit 2 so that the upper door roller may also rectilinearly move at a predetermined distance after moving diagonally or curvedly.

Here, the upper meandering rail unit 2 is extended with different starting positions at a curved line or a diagonal line on both side surfaces of the guide 4 of the upper meandering rail unit 2 so that any one upper door roller 3, which comes into rolling contact with any one of both the side surfaces of the guide 4 of the upper meandering rail unit 2, moves at a distance longer than a rectilinear movement distance of the other upper door roller 3 when a direction of the upper door roller 3 is converted into a curved or diagonal direction, and a guide groove 4c is formed in any one of both the side surfaces of the guide 4 having a diagonal or curved surface, which is a diagonal or curved surface of the guide 4 of the upper meandering rail unit 2, so that the upper door roller 3 meanderingly moves and comes into rolling contact with both the side surfaces of the guide 4 of the upper meandering rail unit 2 which has a diagonal or curved surface.

Meanwhile, the object is achieved by an upper door roller unit of a window and door system, which is installed on an upper end of a window frame, and has two or more rollers 3d and 3e provided on a single vertical shaft 3a or a single diagonal shaft 3b, such that when the rollers 3d and 3e move on the upper linear rail unit 1 and the upper meandering rail unit 2 of claim 1, the rollers 3d and 3e rotate in the directions opposite to each other in a state in which the rollers 3d and 3e maintain rolling contact points with different guides 4a and 4b

In addition, the object is also achieved by an upper door roller unit of a window and door system, which is installed on an upper end of a window frame, and has rollers 3e provided on two or more shafts 3a and 3b having a diagonal or vertical shape, such that when the respective rollers 3e move on the upper linear rail unit 1 and the upper meandering rail unit 2 of claim 1, the rollers 3e rotate in the directions opposite to each other in a state in which the rollers 3 maintain rolling contact points with a vertical guide 4a or a diagonal guide 4b, respectively.

Here, the shafts 3a and 3b are laterally spaced apart from each other at a predetermined distance so that the rollers 3e do not interfere with each other.

The object is achieved by an upper door roller unit of a window and door system, which is installed on an upper end of a window frame, and is installed in plural numbers, such that a plurality of upper door rollers 3 is spaced apart from each other in one side rectilinear line at a predetermined distance, one or more upper door rollers 3 are installed at the other side between the plurality of upper door rollers 3, and when the upper door roller 3 at the one side is guided toward the other side by a protruding portion 13, the upper door roller 3 at the other side is inserted into a groove portion 14

Further, the object is achieved by a lower rail unit of a window and door system, including: a lower linear rail unit 21 which is installed on a lower end of a window casing, and opened upward so as to rectilinearly guide a plurality of lower door rollers 20 which is installed on a lower end of a window frame and has a vertical shaft 3a or a diagonal shaft 3b; a lower meandering rail unit 22 which is opened upward so as to be connected to the lower linear rail unit 21 with the same cross section, and installed to be connected to one side end of the lower linear rail unit 21, and diagonally or curvedly formed so as to diagonally or curvedly guide the door roller 20; and guides 23 which are installed integrally or as separate bodies on both side surfaces in the lower linear rail unit 21 and the lower meandering rail unit 22, and form rolling contact points with the plurality of lower door rollers 20 so as to allow the plurality of lower door rollers 20 to slide.

Further, it is preferable that the lower meandering rail unit 22 further includes a rectilinear portion at an end of the lower meandering rail unit 22 so that the lower door roller may also rectilinearly move at a predetermined distance after moving diagonally or curvedly.

Here, an interval between both the guides 23 of the meandering rail unit 22 is configured to have any one width among a predetermined narrow width, a predetermined wide width, and the same width so that the lower door roller 20 is guided based on a movement direction of the lower door roller 20

In addition, it is preferable that any one of the guides 23 is a diagonal guide 23a which is diagonally formed so that a contact point with the door roller 20 is formed at a diagonal surface, or a vertical guide 23b which is vertically formed so that a contact point with the door roller 20 is formed at a vertical surface.

Further, a catching guide 23c is extended on any one of upper and lower ends of the diagonal guide 23a at a predetermined angle in any one direction of upper and lower directions such that the lower door roller 20 comes into rolling contact with the diagonal guide 23a and the catching guide 23c at the same time and slides.

In addition, the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20

Further, any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

In addition, in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

Further, it is preferable that a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

Meanwhile, the object is achieved by a lower rail unit of a window and door system, including: one or more lower linear rail units 21 which are installed on a lower end of a window casing, are opened upward so as to rectilinearly guide a lower door roller 20 that is installed on a lower end of a window frame, have guides 23 that are diagonally or rectilinearly formed at both sides thereof, and are rectilinearly formed to have a predetermined length; and a lower meandering rail unit 22 which diagonally or curvedly guides the lower door roller 20, which rectilinearly moves on the lower linear rail unit 21, so as to operate the window frame in a horizontal direction, is installed to be connected to one side end of the lower linear rail unit 21 so as to be connected to the lower linear rail unit 21 with the same cross section, and includes a plurality of protruding portions 13 that protrudes at a predetermined position of one side surface of any one of both the guides 23 so as to guide the lower door roller 21 toward the other side surface, and a groove portion 14 that is formed in an inner surface of the other guide 23 so that the lower door roller 21, which comes into rolling contact with the guide 23 and moves, is inserted into the groove portion 14 by the protruding portion 13 when the lower door roller 21 is guided toward the other side surface.

Further, it is preferable that any one of the guides 23 is a diagonal guide 23a which is diagonally formed so that a contact point with the lower door roller 20 is formed at a diagonal surface, or a vertical guide 23b which is vertically formed so that a contact point with the door roller 20 is formed at a vertical surface.

In addition, it is preferable that the lower rail unit further includes a catching guide 23c which is extended from any one of upper and lower ends of the diagonal guide 23a at a predetermined angle in any one direction of upper and lower directions.

Further, the guides 23 are configured as one set of the diagonal guide 23a, which is diagonally formed so that a contact point is formed at the diagonal surface, and the vertical guide 23b, which is vertically formed so that a contact point is formed at the vertical surface, or are configured as one set of the diagonal guide 23a and the diagonal guide 23a

Here, any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

Further, it is preferable that in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

In addition, a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

Meanwhile, the object is achieved by a lower rail unit of a window and door system, including: one or more lower linear rail units 21 which are installed on a lower end of a window casing, protrude upward so as to rectilinearly guide a lower door roller 20, which is installed on a lower end of a window frame and has a vertical shaft 21a or a diagonal shaft 21b, while coming into rolling contact with the lower door roller 20, are rectilinearly formed to have a predetermined length, and have guides 23 that are formed to have a vertical surface or a diagonal surface formed at both sides thereof; and a lower meandering rail unit 22 which diagonally or curvedly guides the lower door roller 20, which rectilinearly moves on the lower linear rail unit 21, so as to operate a window frame in a horizontal direction, is installed to be connected to the lower linear rail unit 21 so as to be connected to the lower linear rail unit 21 with the same cross section, and has guides 23, which are diagonally or curvedly extended, and a rectilinear portion 22a that is rectilinearly formed to have a predetermined length and extended.

Further, it is preferable that the lower meandering rail unit 22 further includes a rectilinear portion at an end of the lower meandering rail unit 22 so that the lower door roller may also rectilinearly move at a predetermined distance after moving diagonally or curvedly.

Here, the lower meandering rail unit 22 is extended with different starting positions at a curved line or a diagonal line on both side surfaces of the guide 23 of the lower meandering rail unit 22 so that any one lower door roller 20, which comes into rolling contact with any one side surface of the guide 23 of the lower meandering rail unit 22, moves at a distance longer than a rectilinear movement distance of the other lower door roller 20 when a direction of the lower door roller 20 is converted into a curved or diagonal direction, and a guide groove 24 is formed in any one of inner and outer surfaces of the diagonal surface or the curved surface, which is a diagonal or curved surface of the guide 23 of the lower meandering rail unit 22, so that the lower door roller 20 meanderingly moves and comes into rolling contact with the inner and outer surfaces of the diagonal or curved surface of the guide 23 of the lower meandering rail unit 22

Further, it is preferable that any one side surface of the guide 23 is a diagonal guide 23a which is diagonally formed so that a contact point with the door roller 20 is formed at a diagonal surface, or a vertical guide 23b which is vertically formed so that a contact point with the door roller 20 is formed at a vertical surface.

In addition, it is preferable that a catching guide 23c is extended on any one of upper and lower ends of the diagonal guide 23a at a predetermined angle in any one direction of upper and lower directions such that the lower door roller 20 comes into rolling contact with the diagonal guide 23a and the catching guide 23c at the same time and slides.

Further, the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20

In addition, any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

Further, in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

In addition, a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes outward from the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

Meanwhile, the object is achieved by a lower door roller unit of a window and door system, including: a shaft 35 which is installed on a lower end of a window frame, and provided in the form of any one of a rectilinear shape and a diagonal shape; a bearing 26 which is axially coupled to the shaft 35; a rolling wheel 51 which is coupled to enclose an outer circumferential portion of the bearing 26, and has a diagonal contact surface formed on an outer diametric surface thereof; and a catching and supporting portion 51a which is formed on any one of upper and lower ends of the diagonal contact surface of the rolling wheel 51 so as to be extended at a predetermined angle in any one direction of upper and lower directions.

Meanwhile, the object is achieved by a lower door roller unit of a window and door system, including: a shaft 35 which is installed on a lower end of a window frame, and provided in the form of any one of a rectilinear shape and a diagonal shape; two or more bearings 26 which are configured in a row or in a plurality of rows and axially coupled to the shaft 35 in upper and lower directions; and a rolling wheel 51 which is coupled to enclose the bearing 26 or an outer circumferential portion of the bearing 26, and has a diagonal contact surface formed on an outer diametric surface thereof.

Further, another shaft 35 protrudes integrally or as a separate body downward at a center of the rolling wheel 51, and the bearing 26 or the rolling wheel 51 is coupled to a lower end of the shaft 35, which protrudes downward, so as to be rotatable.

Meanwhile, the object is achieved by a lower door roller unit of a window and door system, including: a rolling wheel 51 which is installed on a lower end of a window frame, and has an outer diametric surface that is diagonally formed; a shaft 35 which integrally protrudes upward at a rotation center of the rolling wheel 51; and a bearing 26 which is coupled to the shaft 35 and the window frame.

Further, it is preferable that the lower door roller unit includes a supporting portion 58 which is formed on any one of upper and lower ends of the rolling wheel 51 so as to be extended at a predetermined angle in any one direction of upper and lower directions.

Meanwhile, the object is achieved by a lower door roller unit of a window and door system, including: a wheel portion 54 which is formed in a cylindrical shape having a predetermined height; an upper rolling wheel 51a which has an upper shaft 55 and a lower shaft 56 that integrally protrude at upper and lower ends of a central portion of the wheel portion 54; an upper bearing 52 which is axially coupled to an outer diameter of the upper shaft 55 and fixed to a window frame so that the upper rolling wheel 51a and the upper shaft 55 rotate smoothly; and a lower rolling wheel 51b which comes into rolling contact with a guide 23 of a lower rail unit coupled to a window casing so that the lower shaft 56 rotates smoothly.

Further, the lower door roller unit includes a sliding portion 40 which is formed as an inclined surface having a predetermined angle downward at a predetermined position of an outer diametric surface of any one of the upper rolling wheel 51a and the lower rolling wheel 51b

In addition, the lower door roller unit further includes a supporting portion 58 which is formed at an end of the sliding portion 40 of any one of the upper rolling wheel 51a and the lower rolling wheel 51b, which have the sliding portion 40, so as to be extended vertically or at a predetermined angle in any one direction of upper and lower directions.

Meanwhile, the object is achieved by a lower door roller unit of a window and door system, including: a wheel portion 54 which is formed in a cylindrical shape having a predetermined height; a lower rolling wheel 51b which has a shaft 35 that integrally protrudes upward at a rotation center of the wheel portion 54; an upper rolling wheel 51a which is axially coupled to the shaft 35 so as to be freely rotatable, and comes into rolling contact with a guide 23 of a lower rail unit coupled to a window casing; and a bearing 26 which is axially coupled to the shaft 35 at a position of an upper portion of the upper rolling wheel 51a, and fixed to a window so as to smoothly rotate the shaft 35

Further, the lower door roller unit includes a sliding portion 40 which is formed as an inclined surface having a predetermined angle in any one direction of upper and lower directions at a predetermined position of an outer diametric surface of any one of the upper rolling wheel 51a and the lower rolling wheel 51b

In addition, the lower door roller unit further includes a supporting portion 58 which is formed at any one of upper and lower ends of the sliding portion 40 having a diagonal surface, which is formed on any one of the upper and lower rolling wheels 51a and 51b, so as to be extended vertically or at a predetermined angle in any one direction of upper and lower directions.

Further, the lower door roller unit includes a rotary ring 57 which is made of a soft material and coupled to an outer diametric surface of any one of the upper rolling wheel 51a and the lower rolling wheel 51b

### Advantageous Effects

A rotation axis of the wheel installed in the door roller unit is disposed in a vertical direction or in a diagonal direction, such that a state in which a posture of a window is parallel to that of a window casing may be maintained, and movement motion directions may be freely implemented as complex motion such as linear motion and meandering motion, and thereby, the linear motion is performed when the window is opened and closed so that the movement of the window is not hindered, and the meandering motion is performed when the window is closed so that the window and a window casing come into close contact with each other.

In addition, according to the window operation apparatus of the window and door system according to the present invention, the rotation axis of the wheel installed in the door roller unit is disposed in a vertical direction or in a diagonal direction, such that a height (size) of the door roller unit is reduced, and thereby, a space between the window casing and the window may be minimized, and thereby, a configuration such as a skirt, which is provided to shield the door roller unit, is not needed, and a consumption amount of materials, which constitute windows and doors, may be remarkably reduced.

In addition, the window operation apparatus of the window and door system according to the present invention may provide a large biased displacement for the meandering motion, and thereby, a sufficient distance at which the window is operated in left and right directions may be secured, such that a degree of close contact between the window and the window casing may be improved, thereby improving effects of preventing wind and sound.

### DESCRIPTION OF DRAWINGS

FIGS. 1 and 2 are views illustrating a structure of an upper window operation apparatus of a window and door system according to the present invention.

FIGS. 3 and 4 are views illustrating another exemplary embodiment of an upper rail according to the present invention.

FIG. 5 is a view illustrating yet another exemplary embodiment of the upper window operation apparatus of the window and door system according to the present invention.

FIGS. 6 and 7 are views illustrating an operational state of FIG. 5

FIGS. 8 to 11 are views illustrating structures and operational states in states in which rollers are installed to a plurality of shafts in the upper window operation apparatus of the window and door system according to the present invention.

FIG. 12 is a view illustrating still yet another exemplary embodiment of the upper window operation apparatus of the window and door system according to the present invention.

FIGS. 13 and 14 are views illustrating a structure of a lower rail unit according to the present invention.

FIGS. 15 to 18 are views illustrating operational states in which a door roller is rectilinearly, and curvedly or diagonally moved on the lower rail unit according to the present invention.

FIG. 19 is a view illustrating another exemplary embodiment of the lower rail unit according to the present invention together with an assembly structure of the door roller.

FIGS. 21 to 25 are views illustrating structures and operational states of the door roller, which has rollers installed to the plurality of shafts, and a rail in the lower rail unit according to the present invention.

FIG. 26 is a partially cut out exploded perspective view illustrating a structure of a door roller according to a first exemplary embodiment of a lower door roller unit of the present invention.

FIG. 27 is a cross-sectional view illustrating the structure of the door roller according to the first exemplary embodiment of the lower door roller unit of the present invention.

FIG. 28 is a partially cut out exploded perspective view illustrating a structure of a door roller according to a second exemplary embodiment of the lower door roller unit of the present invention.

FIG. 29 is a cross-sectional view illustrating the structure of the door roller according to the second exemplary embodiment of the lower door roller unit of the present invention.

FIG. 30 is a top plan view of a door roller according to a third exemplary embodiment of the lower door roller unit of the present invention.

FIG. 31 is a cross-sectional view taken along line A-A of FIG. 30

FIG. 32 is a cross-sectional view taken along line B-B of FIG. 30

FIG. 33 is a view illustrating a state in which a door roller unit and a lower rail according to the present invention are assembled.

FIG. 34 is a view illustrating a state in which the door roller unit and the lower rail according to the present invention are assembled.

FIG. 35 is a view illustrating a state in which the door roller unit and the lower rail of FIG. 34 are operated.

FIG. 36 is a view illustrating a state in which the door roller unit and the lower rail of FIG. 33 are operated.

FIGS. 37 to 43 are cross-sectional views illustrating structures of the door roller unit according to the present invention, and states in which the door roller unit and the lower rail are assembled.

FIG. 44 is a view for explaining a window operation apparatus of a window and door system according to the first exemplary embodiment of the present invention.

FIG. 45 is a perspective view illustrating extracted main constituent elements of the window operation apparatus of the window and door system according to the first exemplary embodiment of the present invention.

FIGS. 46 and 47 are a top plan view and a side view for explaining an operation of the window operation apparatus of the window and door system according to the first exemplary embodiment of the present invention.

FIG. 48 is a view for explaining another exemplary embodiment of a window casing for the window operation apparatus of the window and door system according to the first exemplary embodiment of the present invention.

### DESCRIPTION OF MAIN REFERENCE NUMERALS OF DRAWINGS

1: Upper linear rail unit
2: Upper meandering rail unit
3: Upper door roller
4: Guide
11: Upper linear rail unit
12: Upper meandering rail unit
13: Protruding portion
14: Groove portion
20: Lower door roller
21: Lower linear rail unit
22: Lower meandering rail unit
23: Guide
24: Guide groove
25: Protruding guide
26: Bearing
31: Upper plate
32: Lower plate
33: Wheel
34: Ball
35: Shaft
36: First through hole
37: Second through hole
38: Threaded portion
39: Nut portion
40: Sliding portion
41: Elastic sliding portion
42: Coupling hole
43: Fixing member
44: Fastening member
50: Rail
51: Rolling wheel
52: Upper bearing
53: Lower bearing
54: Wheel portion
55: Upper shaft
56: Lower shaft
57: Rotary ring
58: Supporting portion
60: Shaft

### BEST MODE

The present invention relates to an upper rail unit of a window and door system, an upper door roller unit of a window and door system, an upper window operation apparatus of a window and door system, a lower rail unit of a window and door system, a lower door roller unit of a window and door system, and a lower window operation apparatus of a window and door system, and hereinafter, exemplary embodiments will be described for each unit while sequentially explaining units of an upper window and an operation apparatus thereof, and units of upper and lower windows and an operation apparatus thereof.

In addition, the window and door system is applied to all of the doors and windows that are variously provided as opening and closing doors, collapsible doors, foldable doors, sliding doors, hinged doors, and fixed type windows, and hereinafter, the term for all the aforementioned configurations are collectively referred to as a window, but implementation of the window needs to be applied to all the doors and windows.

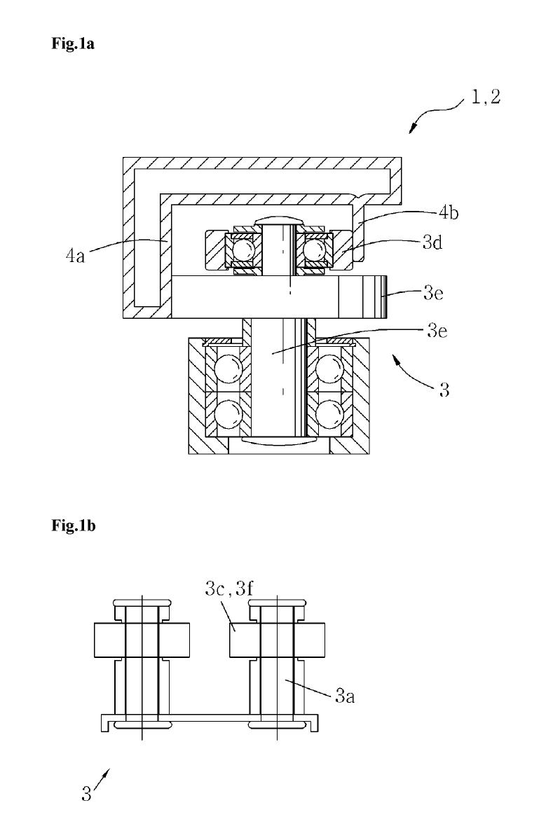

First, an upper rail unit of the window and door system will be described below with reference to FIGS. 1 to 5

### First Exemplary Embodiment

First, an upper rail unit of the window and door system is installed on an upper end of a window casing so as to guide an upper door roller 3, which is installed on an upper end of a window frame, in any one direction among a rectilinear direction, a curved direction, and a diagonal direction.

The upper rail unit of the window and door system includes an upper linear rail unit 1, and an upper meandering rail unit 2

As illustrated in FIG. 1A, the upper linear rail unit 1 has a structure that is opened downward in a shape like a “ [symbol] ” shape, and is rectilinearly formed in a longitudinal direction so as to rectilinearly guide the upper door roller 3

Here, the upper linear rail unit 1 is opened downward such that guides 4 are formed at both sides thereof, and in this case, as illustrated in FIGS. 1B, 1C, and 1D, a structure of a shape of the guide 4 needs to be designed based on a structure of the upper door roller 3 that comes into rolling contact with the guide 4

That is, the upper door roller 3 is provided in plural numbers such that one or more rotation shafts of the upper door rollers 3 are provided as a vertical shaft 3a or a diagonal shaft 3b based on functions and reliability thereof, and in order for a rolling wheel 3c of the upper door roller 3, which is axially coupled to the rotation shaft, and the guide 4 to form a rolling contact point, both the guides 4 need to be formed in vertical and vertical shapes, vertical and diagonal shapes, or diagonal and diagonal shapes so as to correspond to the vertical shaft 3a and the diagonal shaft 3b

Meanwhile, the upper meandering rail unit 2 serves to curvedly or diagonally guide the upper door roller 3 that is guided by the upper linear rail unit 1 and moved.

Therefore, the upper meandering rail unit 2 is installed to be connected to one end of the upper linear rail unit 1, and in this case, a cross section structure of the upper meandering rail unit 2 needs to be identical to a cross section shape of the upper linear rail unit 1 so that the upper door roller 3, which is moved along the upper linear rail unit 1, may be guided and naturally enters the upper meandering rail unit 2

Here, since the meandering rail unit 2 is provided to diagonally or curvedly introduce and guide the upper door roller 3, an interval between both the guides 4 needs to be configured to have any one width among a predetermined narrow width, a predetermined wide width, and the same width, as illustrated in FIGS. 11, 15, and 16, so that the upper door roller 3 may be naturally and diagonally or curvedly guided based on arrangement and structures of the plurality of upper door rollers 3, and a movement direction of the upper door roller 3

Further, it is preferable that the upper meandering rail unit 2 further includes a rectilinear portion at an end of the upper meandering rail unit 2 so that the upper door roller may also rectilinearly move at a predetermined distance after moving diagonally or curvedly.

Therefore, sliding doors or windows overlap with each other in a state in which the sliding doors or windows are opened, but both the windows are disposed in a “—” shape in a state in which the windows are closed, thereby providing an aesthetically attractive external appearance.

### Second Exemplary Embodiment

Like the first exemplary embodiment, an upper rail unit of a window and door system according to the present invention has an upper linear rail unit 1 that is opened downward, has a predetermined length, and is installed on an upper end of a window casing.

Here, an upper meandering rail unit 2 of the second exemplary embodiment is installed within a movement section of the upper linear rail unit 1

That is, a plurality of protruding portions 13 protrudes on one side surface in the upper linear rail unit 1 so that a movement direction of upper door roller 3 is converted into the other side direction while the upper door roller, which moves while being guided by the upper linear rail unit 1, interferes with the protruding portions 13

Here, it is preferable that the protruding portion 13 is diagonally or curvedly formed so that the upper door roller 3 may be diagonally or curvedly guided and moved while a movement direction of force is automatically converted into an opposite direction to the protruding portion 13

A groove portion 14 is provided in the other side surface of the upper linear rail unit 1 between the plurality of protruding portions 13 so that any one of the upper door rollers 3, which move on the upper linear rail unit 1, may be inserted into the groove portion 14

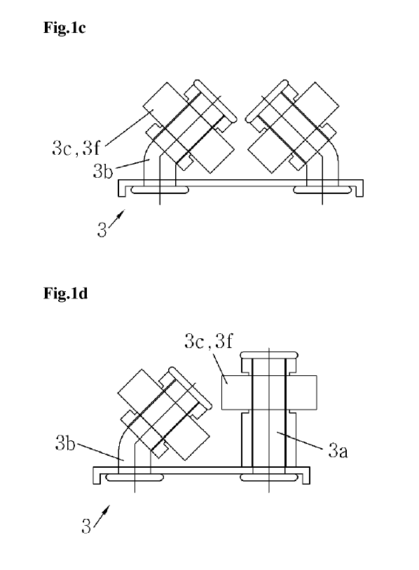

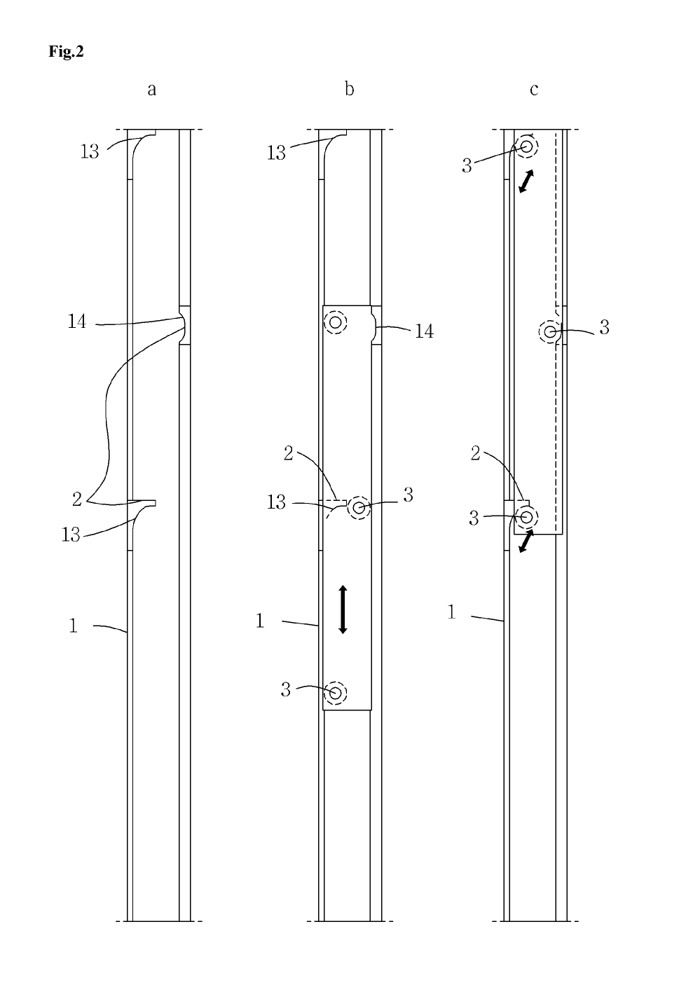

Here, as illustrated in FIGS. 2A, 2B, and 2C, the upper door roller 3, which protrudingly moves by interfering with the protruding portion 13, maintains a contact point with the one side surface of the upper linear rail unit 1, and as illustrated in FIG. 2, the upper door roller 3, which is inserted into the groove portion 14, needs to maintain a contact point with the other side surface of the upper linear rail unit 1

That is, two or more contact points with the plurality of upper door rollers 3 need to be formed at both the guides 4 so that the upper door roller 3 may rectilinearly move, or diagonally and curvedly move without shaking.

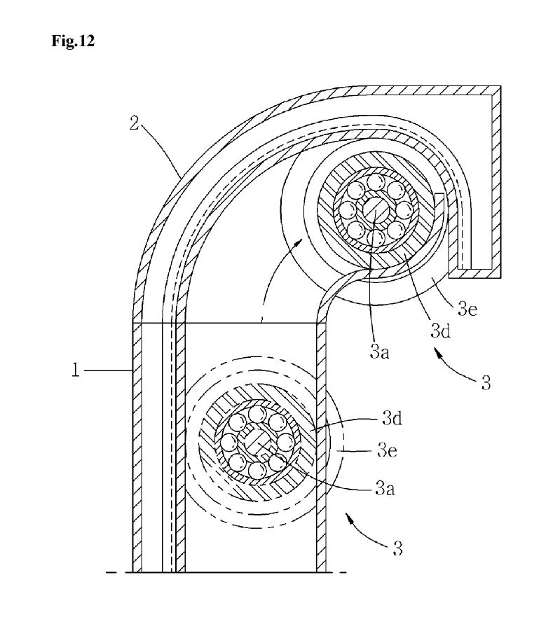

Therefore, the upper door roller 3 is installed on the upper end of the window frame, the plurality of upper door rollers 3 is installed to be spaced apart from each other by a predetermined distance on a rectilinear line at one side, the plurality of upper door rollers 3 is installed to have a separation distance that corresponds to the protruding portions 13 as illustrated in FIG. 12, and the upper door roller 3, which is installed between the protruding portions 13, needs to be installed at a position where the upper door roller 3 may be inserted into the groove portion 14 when the upper door roller 3 is guided in a direction toward the other side (or when the upper door roller 3 is operated in a horizontal direction) by the protruding portion 13

Here, a protruding length of the protruding portion 13 and a size of an outer diameter of the upper door roller 3 need to be designed as illustrated in FIG. 1B, so that the upper door roller 3, which is inserted into the groove portion 14, does not interfere with the protruding portion 13, when the upper door roller 3 moves rectilinearly.

In addition, the protruding portion 13 may be integrally formed with the upper linear rail unit 1 and the upper meandering rail unit 2, or may be formed as a separate body and then may be assembled with or attached to the upper linear rail unit 1 and the upper meandering rail unit 2

### Third Exemplary Embodiment

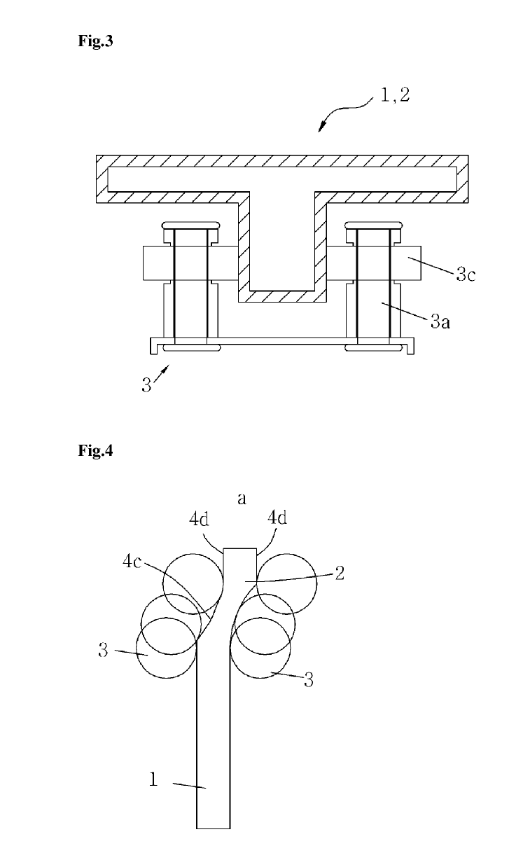

Like the first exemplary embodiment, an upper rail unit of a window and door system according to the present invention has an upper linear rail unit 1 and an upper meandering rail unit 2 that are installed on an upper end of a window casing so as to be connected to each other, and is provided to be applied to a case in which shafts of an upper door roller 3 installed on an upper end of a window frame includes a pair of vertical shafts 3a as illustrated in HG 3, and as illustrated in FIG. 3, guides 4 of the upper linear rail unit 1 and the upper meandering rail unit 2 protrude downward, and the upper door roller 3 rectilinearly moves on the upper linear rail unit 1 in a state in which the upper door roller 3 maintains contact points with both vertical side surfaces of the guide 4, and is diagonally or curvedly guided at the upper meandering rail unit 2 that is installed to be connected to the upper linear rail unit 1

Here, the upper meandering rail unit 2 is extended with different starting positions at a curved line or a diagonal line on both side surfaces of the upper meandering rail unit 2 as illustrated in FIG. 4 so that the upper door roller 3, which comes into rolling contact with any one guide of the guides 4 formed on both the side surfaces of the guides 4 of the upper meandering rail unit 2, may move at a distance longer than a rectilinear movement distance of the other upper door roller 3 when a direction of the upper door roller 3 is converted into a curved or diagonal direction.

That is, a “ [symbol] ” shaped window frame needs to be operated in a horizontal direction, the plurality of upper door rollers 3, which is installed on the upper end of the window frame, maintains contact points with both the side surfaces of the guide 4 in order to operate the window frame in the horizontal direction, any one of the pair of upper door rollers 3 may be spaced apart from the guide 4 when the upper door roller 3 is guided diagonally or curvedly, and on the contrary, the other upper door roller 3 is further pressed against and tightly attached to the guide 4 such that an optimum rolling contact state may not be maintained, and a sliding movement of the upper door roller 3 may not be easily performed.

Therefore, as illustrated in FIGS. 4 and 5, any one side surface of both the side surfaces of the diagonal or curved surface guide 4 of the upper meandering rail unit 2 has a curved or diagonal line that starts prior to that of the other surface, but lengths of the curved or diagonal lines are identical, such that the upper door roller 3, which meanderingly moves first, meets the rectilinear portion 4d first prior to the other upper door roller 3

In this case, in order to allow the upper door roller 3, which moves on the diagonal or curved surface guide 4 of the upper meandering rail unit 2, to always maintain a rolling contact state with the upper meandering rail unit 4, it is preferable that as illustrated in FIGS. 4 and 5A, a guide groove 4c is formed in any one side surface of both the side surfaces of the guide 4, such that the rolling contact state is always maintained even when the pair of upper door rollers 3 moves on the upper meandering rail unit 2

Further, it is preferable that the upper meandering rail unit 2 further includes a rectilinear portion at an end of the upper meandering rail unit 2 so that the upper door roller may also rectilinearly move at a predetermined distance after moving diagonally or curvedly.

Therefore, sliding doors or windows overlap with each other in a state in which the sliding doors or windows are opened, but both the windows are disposed in a “—” shape in a state in which the windows are closed, thereby providing an aesthetically attractive external appearance.

The upper door roller unit of the window and door system according to the present invention will described below with reference to the accompanying drawings.

### First Exemplary Embodiment

An upper door roller unit of a window and door system according to the present invention is a unit which is installed on an upper end of a window frame, and rectilinearly or linearly moves, or diagonally or curvedly moves meanderingly, while being guided by an upper rail unit of the window and door system (hereinafter, referred to as the upper rail unit).

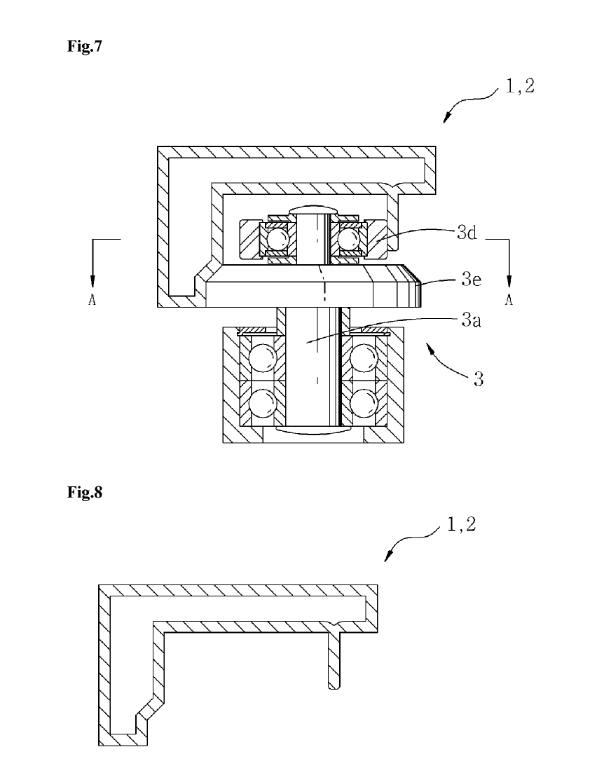

As illustrated in FIG. 7, the upper door roller unit of the window and door system has includes or more rollers 3d and 3e that is provided on a single vertical shaft 3a or a single diagonal shaft 3b, and the rollers 3d and 3e rotate in the directions opposite to each other in a state in which rolling contact points are maintained at both side guides 4a and 4b as illustrated in FIG. 1A when the rollers 3d and 3e move on an upper linear rail unit 1 and an upper meandering rail unit 2 according to <First Exemplary Embodiment> of the upper rail unit.

FIG. 1A illustrates a configuration in which an outer diameter of the upper roller 3d of the rollers 3d and 3e of the upper door roller 3 is smaller than that of the lower roller 3e, but this configuration is just an exemplary embodiment, and an outer diameter of the upper roller 3d may also be greater than that of the lower roller 3e by intention of a designer.

Therefore, when the upper door roller 3 moves, any one roller 3d rotates in a clockwise direction, and the other roller 3e rotates in a counterclockwise direction, and in this case, the rollers 3d and 3e separately rotate in a state in which the rollers 3d and 3e are spaced apart from each other such that when the upper door roller 3 moves, the rotation directions of the rollers 3d and 3e do not interfere with each other.

The movement continues even when the upper door roller 3 enters the upper meandering rail unit 2 via the upper linear rail unit 1 as illustrated in FIG. 11, and in this case, the upper door roller 3 moves while being guided in a diagonal or curved direction by the upper meandering rail unit 2 as illustrated in FIG. 12, and when the upper door roller 3 enters the upper meandering rail unit 2 and then is accommodated at an end of the upper meandering rail unit 2 as illustrated in FIG. 12, this state means a state in which the window frame is operated in a horizontal direction.

Here, when the window frame is operated in the horizontal direction, the rollers 3d and 3e of the upper door roller 3 are tightly attached to the upper linear rail unit 1 and the upper meandering rail unit 2, respectively, and thus, a side surface of the window frame may be tightly attached to a shield plate formed on the window casing.

### Second Exemplary Embodiment

An upper door roller unit of a window and door system according to the present invention is a unit which is installed on an upper end of a window frame, and rectilinearly or linearly moves, or diagonally or curvedly moves meanderingly, while being guided by an upper rail unit of the window and door system (hereinafter, referred to as the upper rail unit).

As illustrated in FIGS. 1B and 1D, the upper door roller unit of the window and door system includes rollers 3f that are provided on two or more shafts 3a and 3b having a diagonal or vertical shape, and when the rollers 3f move on the upper linear rail unit 1 and the upper meandering rail unit 2 according to the first exemplary embodiment of the upper rail unit of the window and door system, the rollers 3f rotate in the directions opposite to each other in a state in which the rollers 3f maintain rolling contact points with different vertical guides 4a and 4b or a diagonal guide 4c as illustrated in FIGS. 7, 8, and 9

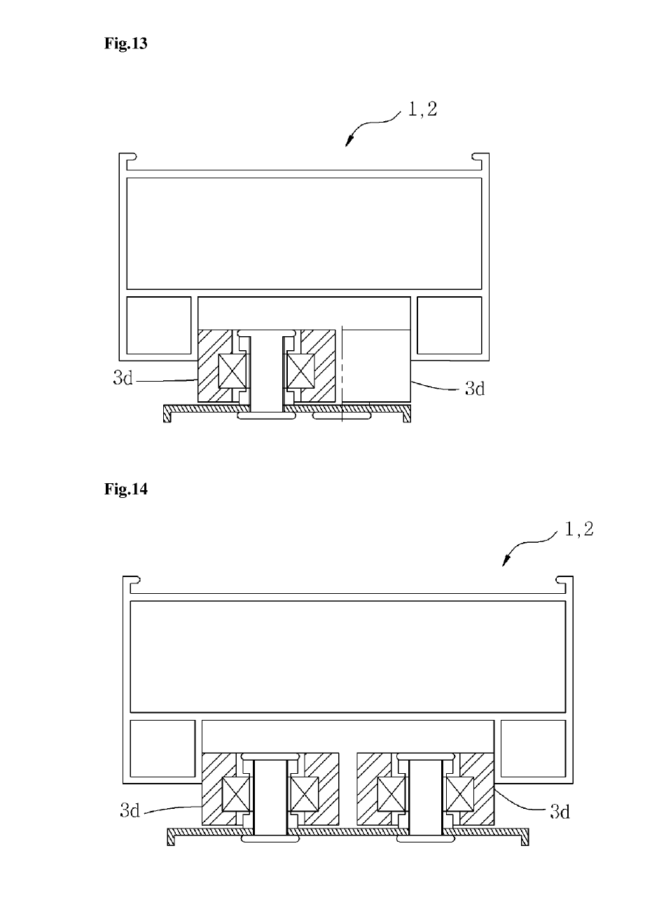

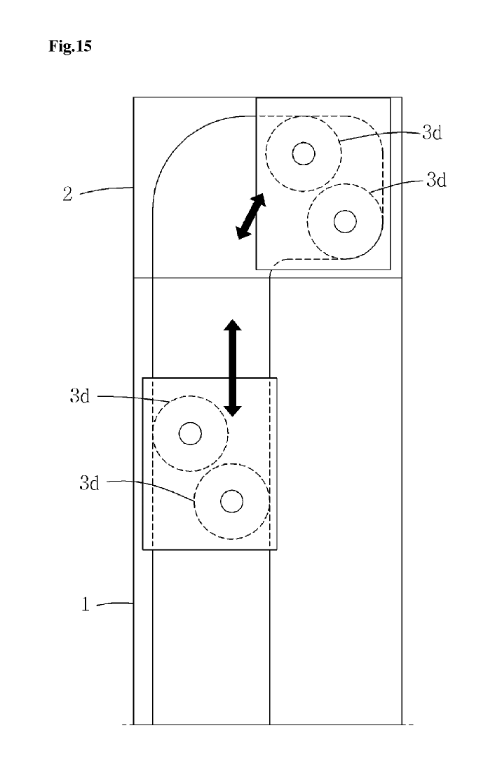

Here, it is preferable that the shafts 3a and 3b are installed to be laterally spaced apart from each other at a predetermined distance, as illustrated in FIGS. 14, 15, and 16, so that the rollers 3f do not interfere with each other.

### Third Exemplary Embodiment

An upper door roller unit of a window and door system according to the present invention is a unit which is installed on an upper end of a window frame, and rectilinearly or linearly moves, or diagonally or curvedly moves meanderingly, while being guided by an upper rail unit of the window and door system (hereinafter, referred to as the upper rail unit).

As illustrated in FIG. 2B, the upper door roller unit of the window and door system includes a plurality of upper door rollers 3 that is installed to be spaced apart from each other at a predetermined distance on a guide one side rectilinear line of an upper linear rail unit 1 of the upper rail unit, and one or more upper door rollers 3 are installed at the other side between the plurality of upper door rollers 3 so that the upper door roller 3 at the other side may be inserted into a groove portion 14 when the upper door roller 3 at one side is guided to the other side by a protruding portion 13

That is, the upper door rollers 3, which are provided to slidingly move on the rail unit suggested in <Second Exemplary Embodiment> of the upper rail unit of the window and door system, and protrudingly move while interfering with the protruding portion 13 of <Second Exemplary Embodiment> of the upper rail unit, maintain a contact point with one side surface of the upper linear rail unit 1, and are installed to be spaced apart from each other at a predetermined distance, as illustrated in FIGS. 2A, 2B, and 2C, and the upper door roller 3, which is inserted into the groove portion 14, needs to maintain a contact point with the other side surface of the upper linear rail unit 1, as illustrated in FIG. 2

That is, two or more upper door rollers 3 of the plurality of upper door rollers 3 need to have contact points with both the guides 4 so that the upper door rollers 3 may rectilinearly move, or diagonally and curvedly move without shaking when the upper door rollers 3 slidingly move.

Therefore, the upper door roller unit is installed on the upper end of the window frame, the plurality of upper door rollers 3 is installed to be spaced apart from each other at a predetermined distance on a rectilinear line at one side, the plurality of upper door rollers 3 is installed to have a separation distance that corresponds to the protruding portions 13 as illustrated in FIGS. 3A, 3B, and 3C, and the upper door roller 3, which is installed between the protruding portions 13, needs to be installed at a position where the upper door roller 3 may be inserted into the groove portion 14 when the upper door roller 3 is guided in a direction toward the other side (or when the upper door roller 3 is operated in a horizontal direction) by the protruding portion 13

Therefore, the upper rail unit and the upper door roller unit of the window and door system of the present invention, which have been described above, include the upper linear rail unit 1, the upper meandering rail unit 2, and the upper door roller 3, and the upper linear rail unit 1 is installed on the upper end of the window casing, and has a structure that is opened downward, as illustrated in FIGS. 1A and 7, or has a structure in which the guide 4 protrudes downward as illustrated in FIGS. 2 to 6, so that the upper door roller 3 installed on the upper end of the window frame may be inserted into and guided by the upper linear rail unit 1

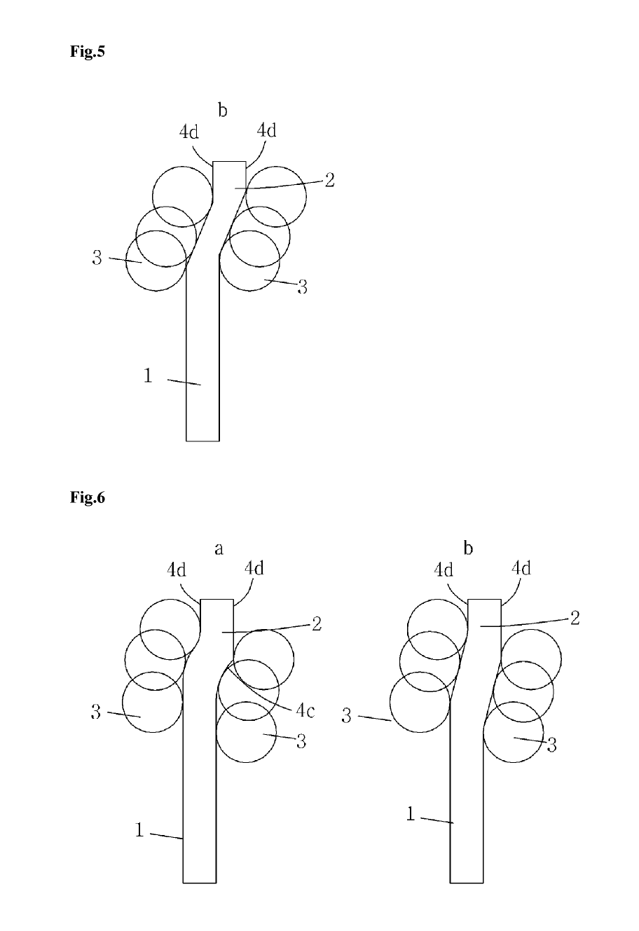

In addition, as illustrated in FIG. 6, the upper linear rail unit 1 is rectilinearly formed to have a predetermined length so that the upper door roller 3 may rectilinearly move within a predetermined section or by a predetermined length.

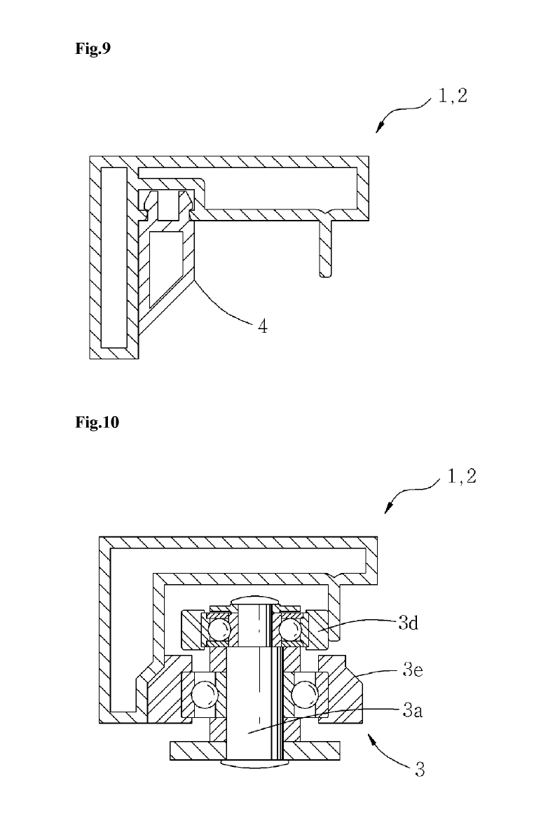

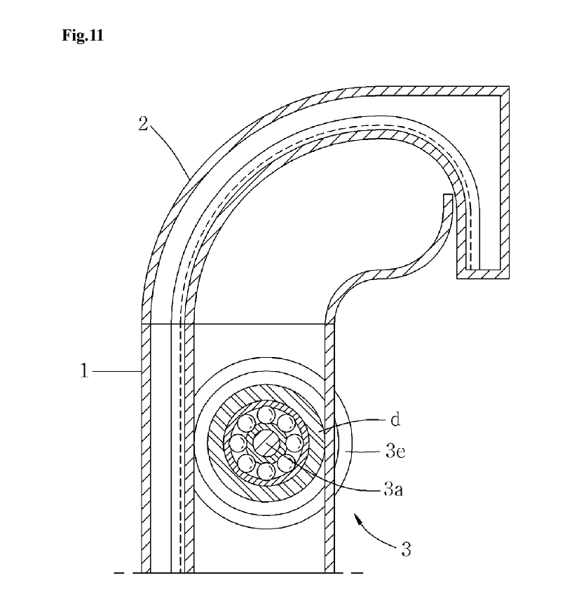

In addition, it is preferable that the upper meandering rail unit 2 has the same cross-sectional structure as the upper linear rail unit 1, and the upper meandering rail unit 2 has a structure in which the cross section thereof is curvedly or diagonally continuous, as illustrated in FIGS. 9 and 10, so that the upper door roller 3, which moves on the upper linear rail unit 1, may move while being guided curvedly or diagonally, and then may be accommodated in the upper meandering rail unit 2

Meanwhile, as illustrated in FIGS. 1A, 7, and 10, the upper door roller 3 includes two or more rollers 3d and 3e which are installed on a single shaft 3a and have different outer diameters, and has a structure in which the rollers 3d and 3e form different rolling contact points, respectively, and rotate in the directions opposite to each other when the rollers 3d and 3e move on the upper linear rail unit 1 and the upper meandering rail unit 2

That is, as illustrated in FIG. 1, when the upper door roller 3 is inserted into the upper linear rail unit 1 and the upper meandering rail unit 2, any one roller 3d of the upper and lower rollers 3d and 3e, which are axially installed on the single shaft 3a, has a rolling contact point with one side surface, and the other roller 3e has a rolling contact point with the other side surface.

Therefore, when the upper door roller 3 moves, any one roller 3d rotates in a clockwise direction, and the other roller 3e rotates in a counterclockwise direction, and in this case, the rollers 3d and 3e separately rotate in a state in which the rollers 3d and 3e are spaced apart from each other such that when the upper door roller 3 moves, the rotation directions of the rollers 3d and 3e do not interfere with each other.

The movement continues even when the upper door roller 3 enters the upper meandering rail unit 2 via the upper linear rail unit 1 as illustrated in FIG. 11, and in this case, the upper door roller 3 moves while being guided in a diagonal or curved direction by the upper meandering rail unit 2 as illustrated in FIG. 11, and when the upper door roller 3 enters the upper meandering rail unit 2 and then is accommodated at an end of the upper meandering rail unit 2 as illustrated in FIG. 11, this state means a state in which the window frame is operated in a horizontal direction.

Here, when the window frame is operated in the horizontal direction, the rollers 3d and 3e of the upper door roller 3 are tightly attached to the upper linear rail unit 1 and the upper meandering rail unit 2, respectively, and thus, a side surface of the window frame may be tightly attached to a shield plate formed on the window casing.

Meanwhile, as illustrated in FIGS. 1 to 7, the door roller of the present invention may include the plurality of rollers 3d and 3e installed on the single shaft 3a, but the rollers 3d may also be provided on two or more shafts, respectively, as illustrated in FIGS. 13 to 15

An operational description of an operation of tightly attaching the shield plate to the window frame will be described when the window operation apparatus of the window and door system is described below, and a detailed description thereof will be omitted.

In other words, the respective rollers 3d form separate rolling contact points and rotate in the directions opposite to each other when the rollers 3d move on the upper linear rail unit 1 and the upper meandering rail unit 2, and in this case, the rollers 3d are installed to be spaced apart from each other, as illustrated in FIGS. 13 to 15, and thus, the rollers 3d naturally move because the rotation of the roller 3d does not interfere with that of the other roller 3d, and the respective rollers 3d maintain the contact points on the upper linear rail unit 1 and the upper meandering rail unit 2 even when the rollers 3d enter and are accommodated in the upper meandering rail unit 2, such that pressing force, which may tightly attach the window frame to the shield plate, may be generated.

The upper rail unit and the upper door roller unit of the window and door system according to the present invention has been described above as the window operation apparatus, and the organic coupling structure thereof will be described below.

That is, as illustrated in FIGS. 2 and 7, the guides 4, which may come into rolling contact with the rollers 3d and 3e of the upper door roller 3, may be integrally formed with the upper linear rail unit 1 and the upper meandering rail unit 2, or the guide 4 may be formed as a separate body and then may be assembled with or attached to the upper linear rail unit 1 and the upper meandering rail unit 2, as illustrated in FIG. 4

In addition, the rolling contact points may be formed only in a state in which outer diametric surfaces of the rollers 3d and 3e are vertical, but it is also preferable that as illustrated in FIG. 7, a part or the entirety of the outer diametric surface is diagonally formed, and the guide 4 is also diagonally formed as illustrated in FIG. 8, such that diagonal lines thereof may come into rolling contact with each other, or a vertical surface and a diagonal surface thereof may come into rolling contact with each other, and thereby, force of pressing the window frame is uniformly transmitted in a direction in which the window frame is intended to be operated in the horizontal direction when the window frame is operated in the horizontal direction.

Furthermore, in a case in which the upper linear rail unit 1 and the upper meandering rail unit 2 are not integrally formed, but are formed as separate bodies and then assembled with each other as illustrated in FIG. 9, it is preferable that the guides 4 are integrally formed along the shapes of the guides of the upper linear rail unit 1 and the upper meandering rail unit 2, and thereafter the guide 4 formed as a single body is assembled with or attached to the upper linear rail unit 1 and the upper meandering rail unit 2 at once, such that the upper door rollers 3 pass through the upper linear rail unit 1 and the upper meandering rail unit 2 while maintaining the rolling contact points with the guide 4 formed as the single body when the upper door rollers 3 pass through the upper linear rail unit 1 and the upper meandering rail unit 2, thereby resolving problems of vibration and rattling due to a boundary point.

Furthermore, the upper door roller 3, which includes two rollers 3d and 3e provided on the single shaft 3a, may be applied and installed, but it is preferable that the rollers are mounted on a plurality of shafts 3a, respectively, as illustrated in FIGS. 13 to 15 so that the respective upper door rollers 3 may move rectilinearly or diagonally while maintaining different rolling contact points with the guide 4

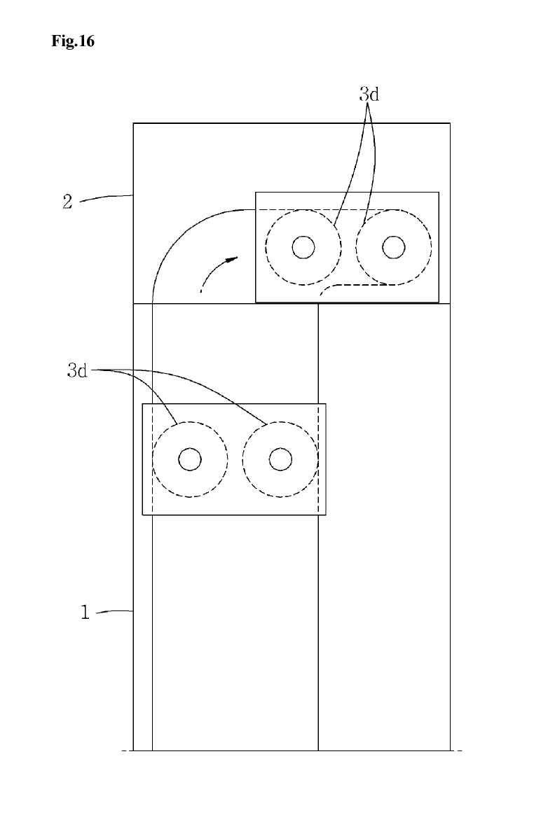

Here, the upper door rollers 3 may be installed to be spaced apart from each other at a predetermined distance toward one side rear surface as illustrated in FIG. 15, and may be installed to be spaced apart from each other at a predetermined distance in the horizontal direction as illustrated in FIG. 16, but the present invention is not limited thereto, but may be variously adopted and changed.

Meanwhile, the lower rail unit of the window and door system according to the present invention includes a lower linear rail unit 21 and a lower meandering rail unit 22 that are installed on a lower end of the window casing, and will be described below for each exemplary embodiment.

### First Exemplary Embodiment

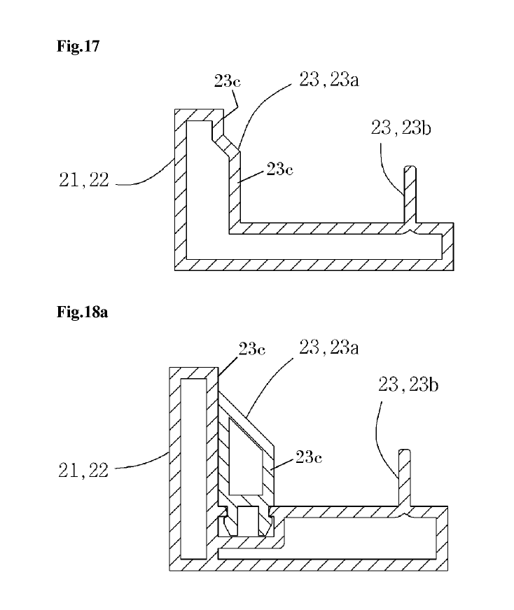

The lower linear rail unit 21 is installed on the lower end of the window casing, and opened upward as illustrated in FIG. 17 so as to rectilinearly guide a plurality of lower door rollers 20 installed on a lower end of the window frame.

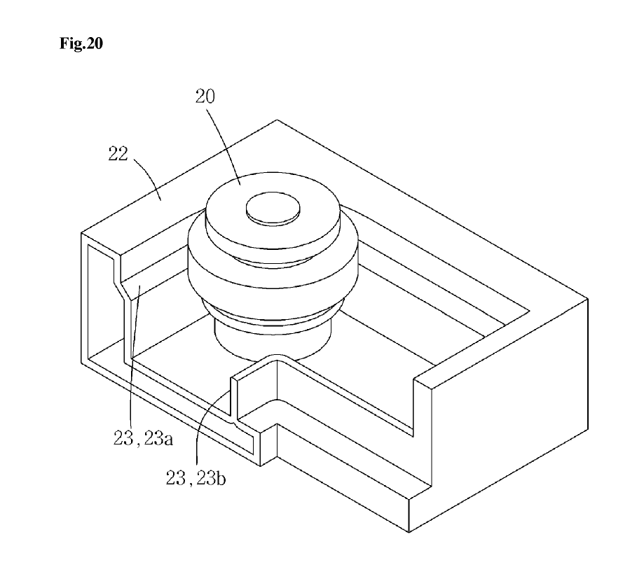

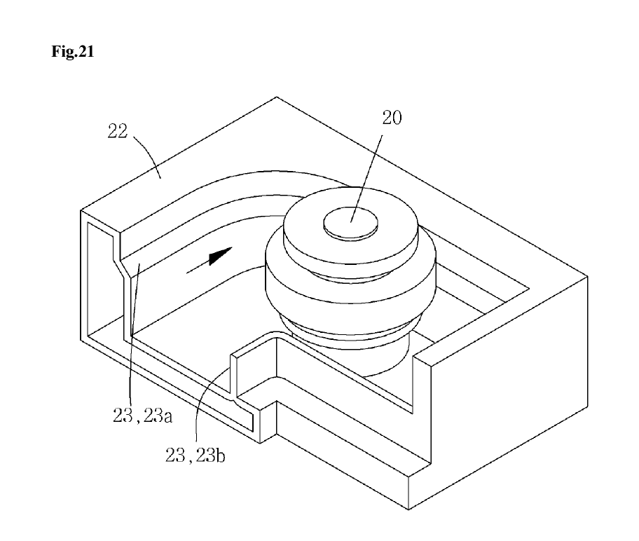

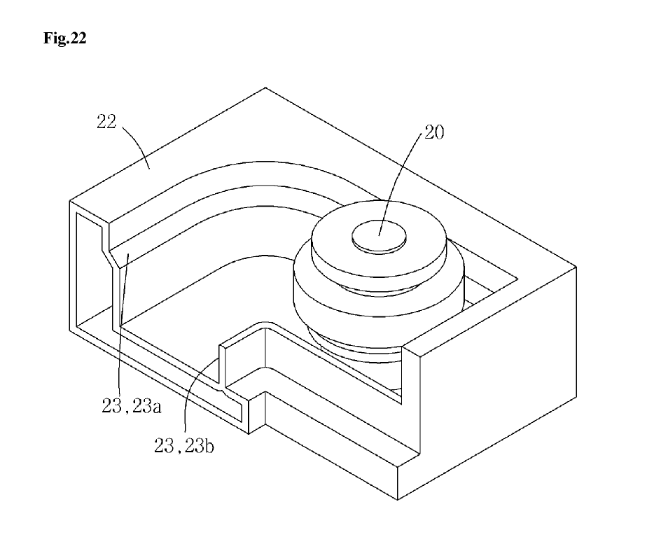

That is, the lower linear rail unit 21 rectilinearly guides the lower door rollers 20 as illustrated in FIG. 15 in a state in which two or more rolling contact points are maintained with the plurality of lower door rollers 20 installed on the lower end of the window frame, the lower meandering rail unit 22 is installed to be connected to one end of the lower linear rail unit 21, and in this case, the lower meandering rail unit 22 needs to guide the lower door rollers 20, which move via the lower linear rail unit 21, as it is, and therefore, it is preferable that the lower meandering rail unit 22 is formed to have the same cross section as the lower linear rail unit 21, and the lower door roller 20 is diagonally or curvedly formed so as to be diagonally or curvedly guided, as illustrated in FIGS. 19 to 23

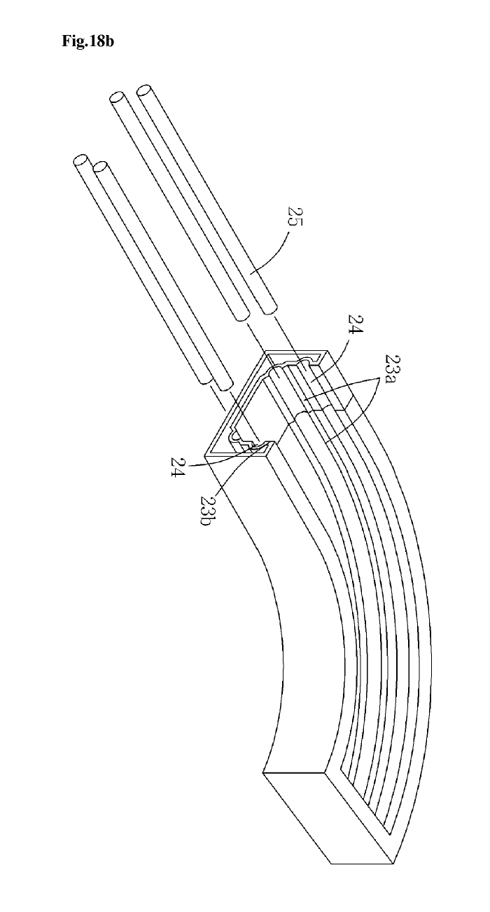

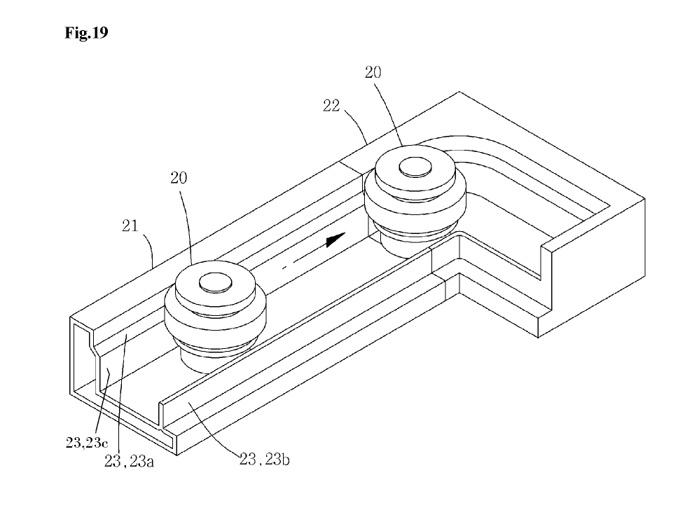

Further, as illustrated in FIGS. 17 and 18A, guides 23 are installed integrally or as separate bodies on both internal side surfaces of the lower linear rail unit 21 and the lower meandering rail unit 22, respectively, and the plurality of lower door rollers 20 slides along the guides 23 while being in rolling contact with the guides 23

Here, among the guides 23 at both sides, any one guide necessarily needs to be formed as a diagonal guide 23a, which is diagonally formed, so that a contact point is formed at the diagonal surface, and the other guide is configured as a diagonal guide 23a which has the same dimension or different dimension based on a structure of the lower door roller 20, or configured as a vertical guide 23b, which is vertically formed, so that a contact point is formed at the vertical surface, and the guides 23 are configured as one set as illustrated in the accompanying FIGS. 17 and 18 such that the lower door rollers 20 have two contact points with the guides 23 at both sides, respectively.

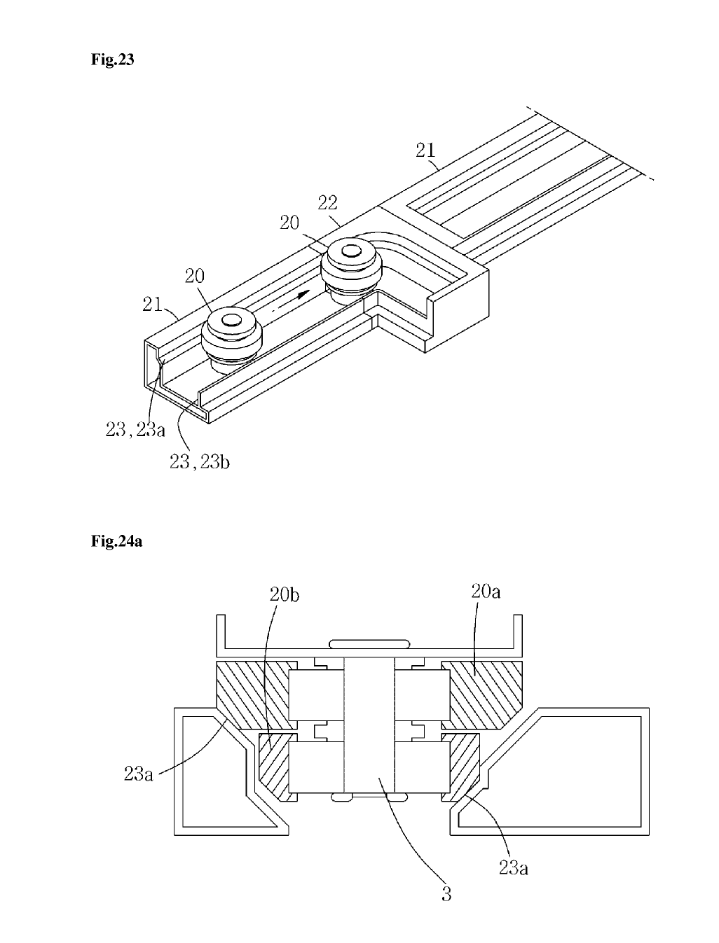

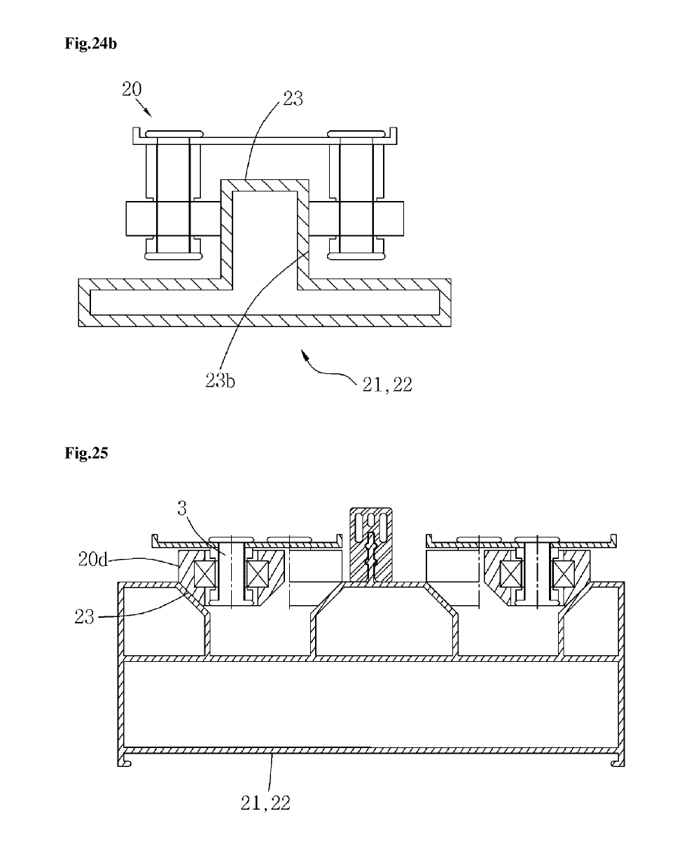

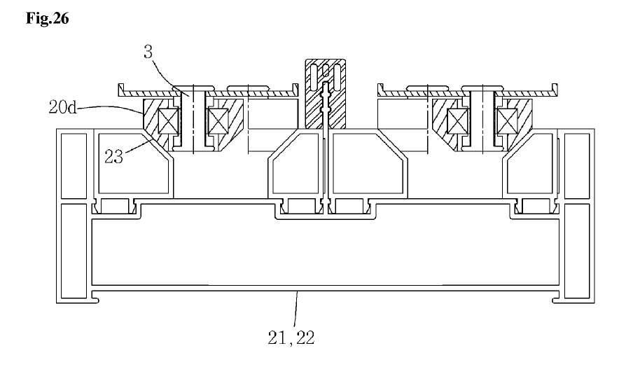

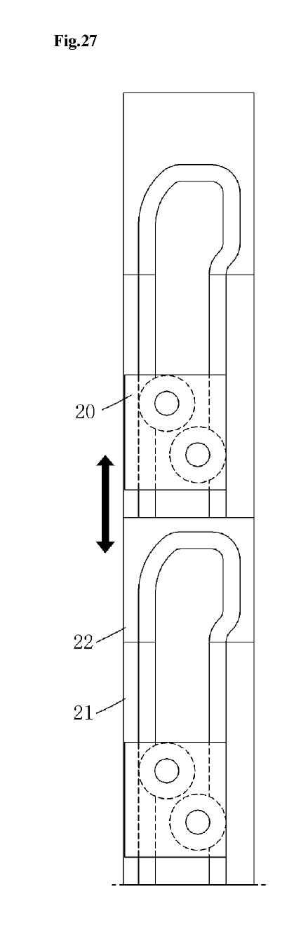

That is, the guides 23 are configured as the diagonal guide 23a and the vertical guide 23b that are combined and configured as one set, the diagonal guide 23a and the vertical guide 23b are configured as one set as illustrated in FIGS. 17 and 18A, or the diagonal guide 23a and the diagonal guide 23a are configured as one set as illustrated in FIGS. 24A, 25, 26, 27, and 29, such that contact points with the lower door roller 20 may be formed.

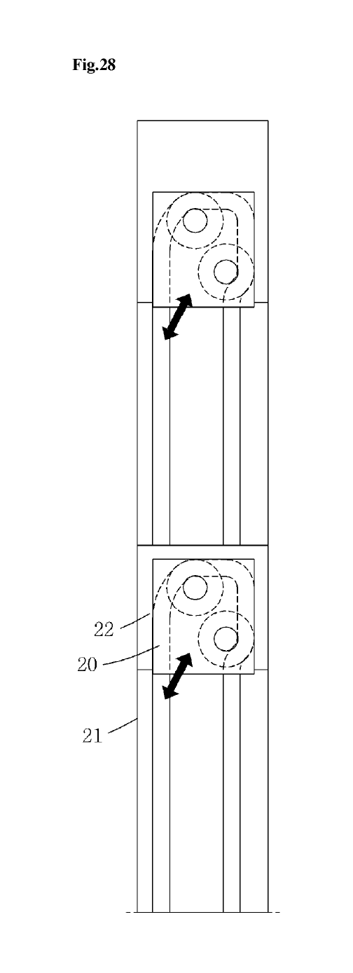

Particularly, it is preferable that as illustrated in FIGS. 19 to 23 and FIGS. 27 to 29, any one of the diagonal guide 23a and the vertical guide 23b is formed to be longer than the other vertical guide 23b or the other diagonal guide 23a so as to relatively increase a movement distance of the lower door roller 20, such that when the lower door roller 20, which is guided along the guide 23, enters the lower meandering rail unit 22 from the lower linear rail unit 21, the lower door roller 20 may move curvedly or diagonally.

Here, regarding the guide 23, as illustrated in FIG. 18A, a single guide 23, which is integrally formed, is continuously assembled with or attached to the lower linear rail unit 21 and the lower meandering rail unit 22 such the a coupling portion between the lower linear rail unit 21 and the lower meandering rail unit 22 forms a sense of unity.

Therefore, when the lower door roller 20 enters the lower meandering rail unit 22 from the lower linear rail unit 21, vibration and rattling due to a connection point do not occur in a case in which the lower linear rail unit 21 and the lower meandering rail unit 22 are formed as separate bodies and then connected to each other, and thereby, the problem, which causes the lower door roller 20 or the guide 23 to be abraded or damaged and shortens a lifespan of the lower door roller 20 or the guide 23, may be resolved.

That is, as illustrated in FIG. 18B, regarding the guide 23, guide grooves 24 are formed in the diagonal guide 23a and the vertical guide 23b at a predetermined interval so as to be elongated in a longitudinal direction thereof, protruding guides 25, which are formed to have a circular or polygonal cross section as illustrated, are inserted into and fixed to the guide grooves 24, one side surface of the protruding guide 25 protrudes as illustrated such that the protruding guides 25 may be continuous at the diagonal guide 23a and the vertical guide 23b, the lower door roller 20 slides while maintaining the rolling contact point with the protruding guide 25, the lower door roller 20 continuously passes through the diagonal guide 23a via the vertical guide 23b without being disconnected, and thereby vibration such as rattling does not occur.

In addition, as illustrated in FIGS. 17 and 18A, in a case in which the diagonal guide 23a and the vertical guide 23b are formed or assembled as one set, it is preferable that the diagonal guide 23a and the vertical guide 23b are formed to have the same height, or any one of the diagonal guide 23a and the vertical guide 23b is installed to have a relatively low height as illustrated in FIG. 18A such that the lower roller is prevented from tilting and deviating from the way in a case in which a plurality of rollers is assembled with a single shaft.

That is, when a window is installed at the window casing or after the window is installed at the window casing, the lower door roller 20 is tilted from the lower linear rail unit 21 or the lower meandering rail unit 22 as a center of a radius of roller rotation of the lower door roller 20, which supports the window, becomes high, and as a result, there may be a problem in that the window collapses, but this problem may be overcome by designing a height difference or the same height of the diagonal guide 23a and the vertical guide 23b

Meanwhile, as illustrated in FIG. 17, a catching guide 23c, which is extended from any one of upper and lower ends of the diagonal guide 23a at a predetermined angle in any one direction of upper and lower directions, is further included, FIG. 17 illustrates the catching guide 23c that is vertically extended from the upper and lower ends of the diagonal guide 23a, but the angle of the catching guide 23c may be variously adopted and changed based on a structure of the lower door roller 20 and intention of a designer, and thus, the present invention is not limited thereto, but may be variously adopted and changed.

Further, it is preferable that the lower meandering rail unit 2 further includes a rectilinear portion at an end of the lower meandering rail unit 2 so that the lower door roller may also rectilinearly move at a predetermined distance after moving diagonally or curvedly.

Therefore, sliding doors or windows overlap with each other in a state in which the sliding doors or windows are opened, but both the windows are disposed in a “—” shape in a state in which the windows are closed, thereby providing an aesthetically attractive external appearance.

### Second Exemplary Embodiment

A lower rail unit of a window and door system according to the present invention will be described below with reference to the accompanying FIG. 23

Of course, like the first exemplary embodiment, a lower linear rail unit 1, which is opened downward and has a predetermined length, is installed on a lower end of a window casing, and here, a lower meandering rail unit 22 of the second exemplary embodiment is installed within a movement section of the lower linear rail unit 21

That is, a plurality of protruding portions 13 protrudes on one side surface in the lower linear rail unit 21 so that a movement direction of the lower door roller 20 is converted into the other side direction while a lower door roller, which moves while being guided by the lower linear rail unit 21, interferes with the protruding portions 13

Here, it is preferable that the protruding portion 13 is diagonally or curvedly formed so that the lower door roller 20 may be diagonally or curvedly guided and moved while a movement direction of force is automatically converted into an opposite direction to the protruding portion 13

A groove portion 14 is provided in the other side surface of the lower linear rail unit 21 between the plurality of protruding portions 13 so that any one of the lower door rollers 20, which move on the lower linear rail unit 21, may be inserted into the groove portion 14

Here, as illustrated in FIG. 23, the lower door roller 20, which protrudingly moves by interfering with the protruding portion 13, maintains a contact point with the one side surface of the lower linear rail unit 21, and as illustrated in FIG. 23, the lower door roller 20, which is inserted into the groove portion 14, needs to maintain a contact point with the other side surface of the lower linear rail unit 21

That is, two or more contact points with the plurality of lower door rollers 20 need to be formed at both the guides 23 so that the lower door roller 20 may rectilinearly move, or diagonally and curvedly move without shaking.

Therefore, the lower door roller 20 is installed on an upper end of a window frame, the plurality of lower door rollers 20 is installed to be spaced apart from each other at a predetermined distance on a rectilinear line at one side, the plurality of lower door rollers 20 is installed to have a separation distance that corresponds to the protruding portion 13 as illustrated in FIG. 23, and the lower door roller 20, which is installed between the protruding portions 13, needs to be installed at a position where the lower door roller 20 may be inserted into the groove portion 14 when the lower door roller 20 is guided in a direction toward the other side (or when the lower door roller 20 is operated in a horizontal direction) by the protruding portion 13

Here, a protruding length of the protruding portion 13 and a size of an outer diameter of the lower door roller 20 need to be designed as illustrated in FIG. 23, so that the lower door roller 20, which is inserted into the groove portion 14, does not interfere with the protruding portion 13, when the lower door roller 20 moves rectilinearly.

In addition, the protruding portion 13 may be integrally formed with the lower linear rail unit 21 and the lower meandering rail unit 22, or may be formed as a separate body and then may be assembled with or attached to the lower linear rail unit 21 and the lower meandering rail unit 22

Meanwhile, in all the exemplary embodiments of the lower rail unit of the window and door system according to the present invention, as also described in the first exemplary embodiment, any one of the guides 23 is a diagonal guide 23a, which is diagonally formed, so that a contact point with the lower door roller 20 may be formed at a diagonal surface, or a vertical guide 23b, which is vertically formed, so that a contact point with the door roller 20 is formed at a vertical surface, and particularly, as illustrated in FIGS. 17 and 18, a catching guide 23c is formed at a predetermined angle on any one of upper and lower ends of the diagonal guide 23a in any one direction of upper and lower directions, thereby maximizing a rolling contact area with the lower door roller 30, and in this case, the catching guide 23c may be formed to have various angles.

In addition, like the first exemplary embodiment, the guides 23 may be configured as one set of the diagonal guide 23a, which is diagonally formed so that a contact point is formed at the diagonal surface, and the vertical guide 23b, which is vertically formed so that a contact point is formed at the vertical surface, or may be configured as one set of the diagonal guide 23a and the diagonal guide 23a.

Furthermore, regarding the guide 23, any one of the diagonal guide 23a and the vertical guide 23b, which are integrally formed to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 may be continuous without being disconnected, and in a case in which the diagonal guide 23a and the vertical guide 23b, or the diagonal guide 23a and the diagonal guide 23a are formed or assembled as one set, it is preferable that the diagonal guide 23a and the vertical guide 23b, or the diagonal guide 23a and the diagonal guide 23a have the same height, or any one thereof is installed to be relatively high, such that design is variously performed while corresponding to a load of the window frame, and uniform operational force may be applied to the window frame when the window frame is slanted, or when the window frame is moved in the horizontal direction.

Further, it is preferable that as illustrated in FIG. 18B, a plurality of guide grooves 24 is also formed at a predetermined interval in any one of the diagonal guide 23a and the vertical guide 23b in the second exemplary embodiment, protruding guides 25, which are formed to have a circular or polygonal cross section, are inserted into and fixed to the guide grooves 24, and one side surface partially protrudes into the lower linear rail unit 21 and the lower meandering rail unit 22 so as to form the diagonal guide 23a or the vertical guide 23b that is continuous without being disconnected such that the contact point with the lower door roller 20 may be formed in the form of a line or a surface.

### Third Exemplary Embodiment

Like the first exemplary embodiment, a lower rail unit of a window and door system according to the present invention includes a lower linear rail unit 11 and a lower meandering rail unit 22 that are installed on a lower end of a window casing so as to be connected to each other, and is provided to be applied to a case in which the lower door rollers 20 installed on a lower end on a window frame are configured as a pair of lower door rollers 20 that is installed to be spaced apart from each other as illustrated in FIG. 24B, and as illustrated in FIG. 24B, guides 23 of the lower linear rail unit 21 and the lower meandering rail unit 22 protrude upward, and the lower door roller 3 rectilinearly moves on the lower linear rail unit 21 in a state in which the lower door roller maintains contact points with both vertical side surfaces 23b of the guide 23, and is diagonally or curvedly guided at the lower meandering rail unit 22 that is installed to be connected to the lower linear rail unit 21

Here, the lower meandering rail unit 22 is extended with different starting positions at a curved line or a diagonal line on both side surfaces of the lower meandering rail unit 22 as illustrated in FIG. 4 so that the lower door roller 20, which comes into rolling contact with any one guide of the guides 23b formed on both side surfaces of the guides 23 of the lower meandering rail unit 22, may move at a distance longer than a rectilinear movement distance of the other lower door roller 20 when a direction of the lower door roller 20 is converted into a curved or diagonal direction.

That is, since the plurality of lower door rollers 20, which is installed on the lower end of the window frame, maintains contact points with both the side surfaces of the guide 23 in order to operate the window frame in the horizontal direction, any one of the pair of lower door rollers 20 may be spaced apart from the guide 23 when the lower door roller 20 is guided diagonally or curvedly, and on the contrary, the other upper door roller 20 is further pressed against and tightly attached to the guide 23 such that an optimum rolling contact state may not be maintained, and a sliding movement of the lower door roller 20 may not be easily performed.

Therefore, as illustrated in FIGS. 24A and 24B, any one side surface of both the side surfaces of the diagonal or curved surface guide 23 of the lower meandering rail unit 22 has a curved or diagonal line that starts prior to that of the other surface, but lengths of the curved or diagonal lines are identical, such that the lower door roller 20, which meanderingly moves first, meets the rectilinear portion first prior to the other lower door roller 20

In this case, in order to allow the lower door roller 3, which moves on the diagonal or curved surface guide 23 of the lower meandering rail unit 22, to always maintain a rolling contact state with the lower meandering rail unit 22, it is preferable that as illustrated in FIG. 24B, a the vertical guide 23b is formed in any one side surface of both the side surfaces of the guide 23, such that the rolling contact state is always maintained even when the pair of lower door rollers 20 moves on the lower meandering rail unit 22

As described above, when the exemplary embodiments of the lower rail unit of the window and door system according to the present invention are collectively described, the diagonal guide 23a and the vertical guide 23b may be configured together, but all of the pair of guides 23 may be configured as the diagonal guides 23a in the lower linear rail unit 21 and the lower meandering rail unit 22, as illustrated in FIG. 24A

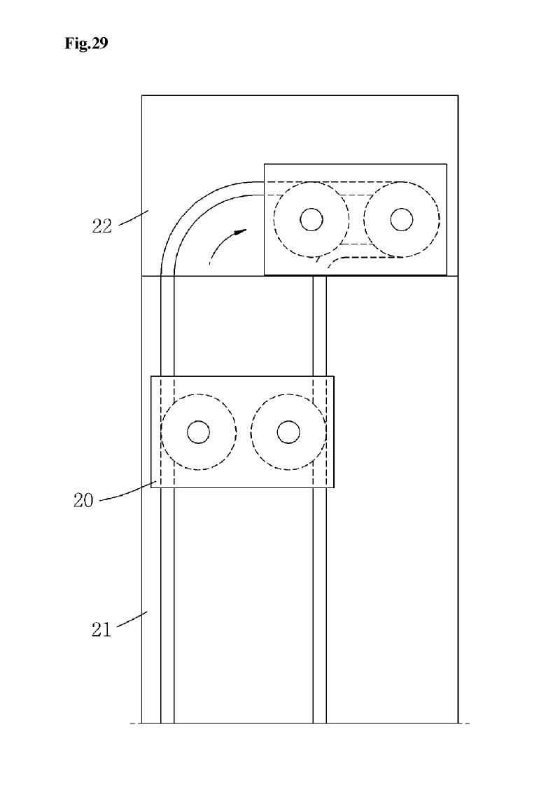

The lower linear rail unit 21 and the lower meandering rail unit 22, which are configured to have only the diagonal guide 23a as described above, may have a narrow width as illustrated in FIGS. 25 to 28, or may have a wide width as illustrated in FIG. 29, depending on the lower door roller 20 that will be described below.

In other words, as illustrated in FIG. 24A, widths of the lower linear rail unit 21 and the lower meandering rail unit 22 are narrow so as to guide the lower door roller 20 in which upper and lower rollers 20a and 20b are installed on a single shaft, the diagonal guide 23a needs to be designed so as to come into rolling contact with the upper roller 20a and the lower roller 20b such that rolling contact heights of the rollers 20a and 20b and the guide 23 cannot help but be different, and the aforementioned configurations are within a range in which the widths and the heights may be slightly changed and designed based on the structure of the lower door roller 20, and therefore, all the aforementioned configurations may belong to the scope of the present invention.

Furthermore, as illustrated in FIGS. 25, 26, 27, 28, and 29, in a case in which rollers 20d are installed on a plurality of shafts 3, respectively, so as to come into rolling contact with the guides 23, intervals of the guides 23, which are provided in the lower linear rail unit 21 and the lower meandering rail unit 22 may be designed to be different depending on an installation interval of the rollers 20d, as illustrated.

In addition, as illustrated, regarding the guide 23, the lower linear rail unit 21 may be integrally formed with the lower meandering rail unit 22, but preferably, the lower linear rail unit 21, the lower meandering rail unit 22, and the guide 23 are formed as separate bodies, the lower linear rail unit 21 and the lower meandering rail unit 22 are assembled with each other, and thereafter, a single guide 23 is assembled with the lower linear rail unit 21 and the lower meandering rail unit 22, such that when the lower door roller 20 enters the lower meandering rail unit 22 via the lower linear rail unit 21, minute oscillation or vibration, which may be generated at a boundary line, are prevented so as to suppress noise generation, thereby preventing products from being damaged due to the vibration.

A configuration of the lower door roller unit of the window and door system according to the present invention will be described below for each exemplary embodiment.

### First Exemplary Embodiment

A lower door roller unit of a window and door system includes one or more lower door rollers 20 that are installed on a lower end of a window frame, and allow the window frame to slidingly move while being guided by a rail unit that is installed on a lower end of a window casing.

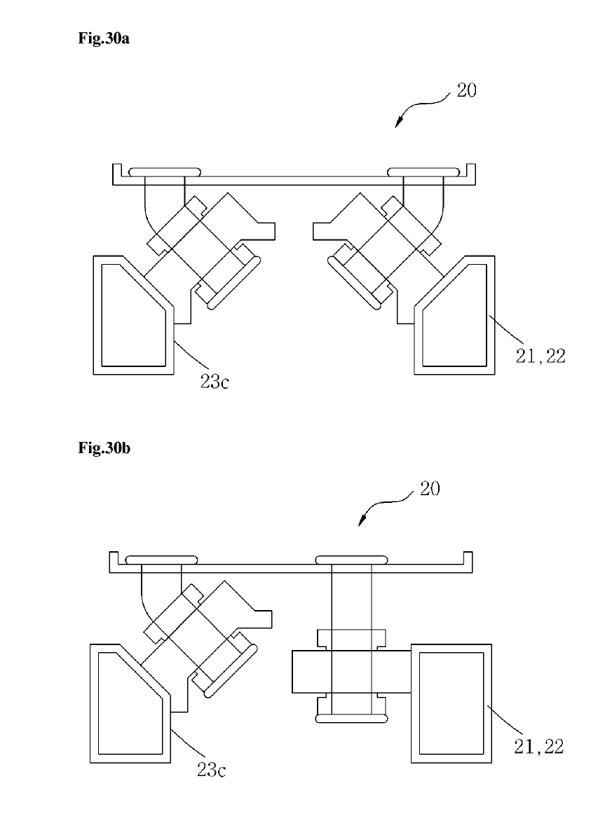

The lower door roller unit is configured by coupling a rolling wheel 51 to be rotatable on a shaft 35 provided in the form of any one of a rectilinear shape or a diagonal shape, and by forming a catching and supporting portion 51a, which is extended at a predetermined angle in upper and lower directions, on any one of upper and lower ends of the rolling wheel 51 coupled to the diagonal shaft 35, as illustrated in FIG. 30A

Here, the rolling wheel 51 and the shaft 35 may be integrally formed, and in this case, it is preferable that a bearing 26 is coupled to an upper end or a lower end of the shaft 35

As illustrated in FIG. 30A, the supporting portion Ma maintains a rolling contact point with a catching guide 23c that is extended toward a lower portion of the diagonal guide 23a of the guide 23 of the lower rail unit, thereby preventing clearance between the shaft 35 and the rolling wheel 51 even though the lower door roller 20 is used over a long period of time in a state in which a load of the window frame is applied to the lower door roller 20

That is, clearance may be formed between the shaft and the rolling wheel because a load of the window frame is concentrated to the diagonal shaft 35, and in this case, the supporting portion 51a and the vertical catching and supporting portion 23c support and prevent the distortion due to the load, and thus, the clearance does not occur even when used over a long period of time.

### Second Exemplary Embodiment

A second exemplary embodiment of a lower door roller unit of a window and door system of the present invention provides a lower door roller 20 or a door roller unit (hereinafter, referred to as a lower door roller 20) which is installed on a lower or upper portion of a window frame and allows the window frame to move linearly, and the window frame may be operated in a horizontal direction or in a meandering direction after linearly moving to a closed state with the window casing, or while linearly moving to the closed state, using the lower door roller 20

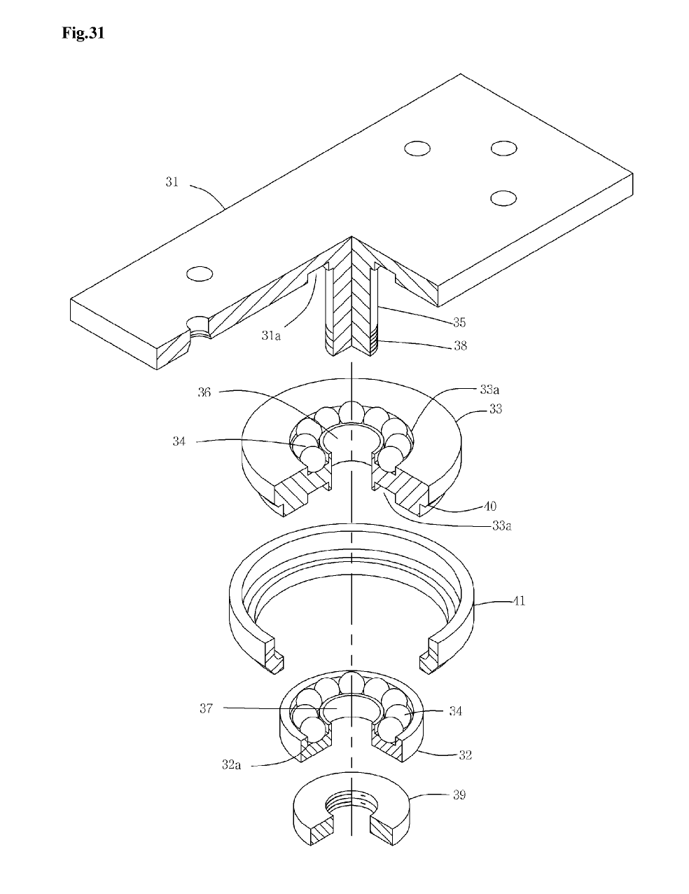

As illustrated in FIGS. 31 to 34, the second exemplary embodiment of the lower door roller 20 of the present invention includes an upper plate 31 and a lower plate 32, one or plurality of wheels 33 that is disposed between the upper plate 31 and the lower plate 32, a structure in which the wheel 33 disposed between the upper plate 31 and the lower plate 32 may be smoothly rotated, and a coupling structure which couples the aforementioned components.

As illustrated in FIG. 31, the upper plate 31 is formed in a plate shape having a predetermined width or breadth, and a shape of the upper plate 31 may be circular, elliptical, or quadrangular, but the present invention is not limited thereto.

In addition, an insertion groove 31a into which a plurality of balls 34 may be inserted is formed in a lower surface of the upper plate 31, and as illustrated, is formed radially based on any one point so as to have a doughnut shape.

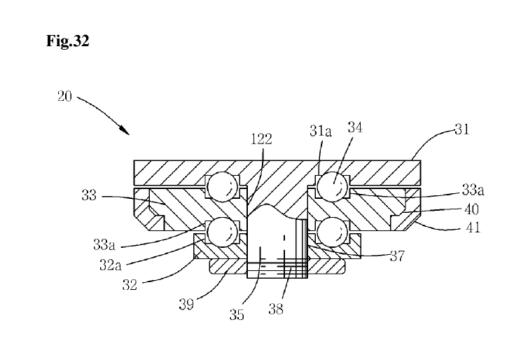

The wheel 33 coupled to the lower portion of the upper plate 31 has an insertion groove 33a, which is formed to correspond to the insertion groove 31a of the lower portion of the upper plate 31 such that the plurality of balls 34 is inserted into the insertion grooves 31a and 33a between the upper plate 31 and the wheel 33, as illustrated in FIGS. 31 and 32, and the upper plate 31 and the wheel 33 come into rolling contact with the plurality of balls 34 so as to be smoothly rotated.

Meanwhile, the insertion groove 33a having a doughnut shape is also formed in a lower portion of the wheel 33 so that the plurality of balls 34 may be inserted into the insertion groove 33a, an insertion groove 32a, which corresponds to the insertion groove 33a formed in the lower surface of the wheel 33, is formed in an upper surface of the lower plate 32 that is disposed below the wheel 33, the plurality of balls 34 is inserted into a space between the insertion groove 33a of the lower portion of the wheel 33 and the insertion groove 32a in the upper surface of the lower plate 32, and the wheel 33 and the lower plate 32 come into rolling contact with the plurality of balls 34 so as to be smoothly operated.

Here, in the second exemplary embodiment of the lower door roller 20 according to the present invention, a cylindrical shaft 35 protrudes downward or upward on the lower surface of the upper plate 31 or the upper surface of the lower plate 32 in order to smoothly rotate the upper plate 31, the wheel 33, and the lower plate 32, particularly, the wheel 33, and allow the upper plate 31, the wheel 33, and the lower plate 32 to have an organic coupling structure.

Further, a first through hole 36 is formed at a center of the wheel 33 so that the shaft 35 may be inserted into the first through hole 36, a second through hole 37 is formed in the lower plate 32 in a case in which the shaft 35 is formed on the upper plate 31, and a second through hole 37 is formed in the upper plate 31 in a case in which the shaft 35 is formed on the lower plate 32, such that the shaft 35 penetrates the first through hole 36 and the second through hole 37

Meanwhile, a threaded portion 38 is formed on an end of the shaft 35 that penetrates the second through hole 37, and a nut portion 39 is fastened to the threaded portion 38 so as to tighten the nut portion 39 and the upper plate 31 or the lower plate 32, which has the shaft 35, at both sides thereof, using fastening force, such that the wheel 33 positioned at the intermediate position and the upper and lower plates 31 and 32 apply uniform force to and tightly attach the plurality of balls 34, which is radially disposed based on the shaft 35, thereby maintaining a secure coupled state, and allowing the wheel 33 to rotate smoothly.

Therefore, even though a load is eccentrically applied to the wheel 33, the upper plate 31 and the lower plate 32 uniformly press the plurality of balls 34 disposed in the insertion grooves 33a of the wheel 33, and thus, the eccentric load is uniformly distributed, thereby reducing a burden of a load.

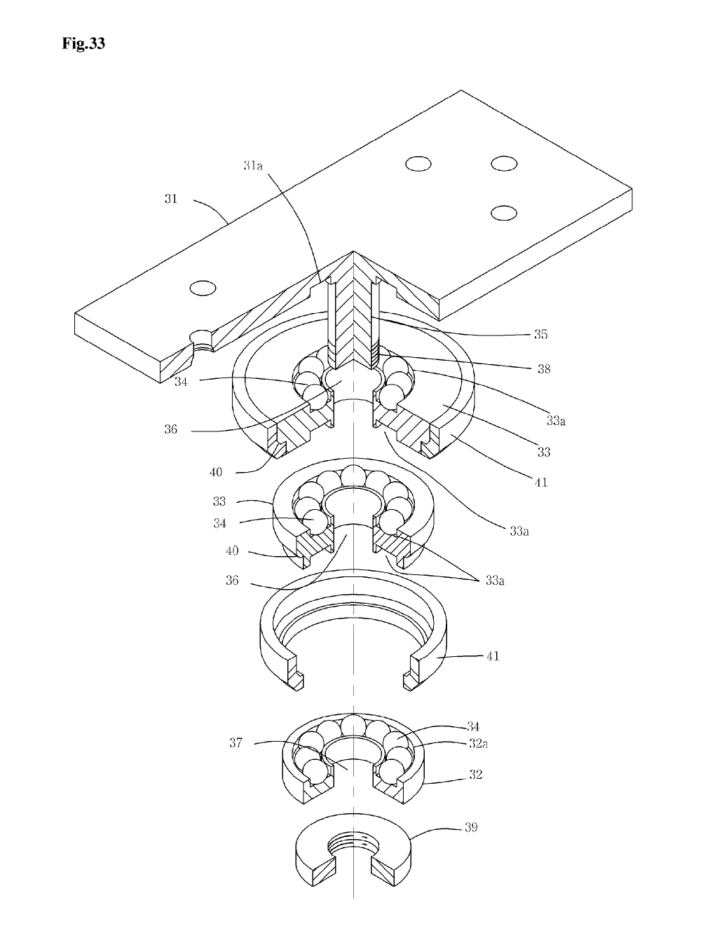

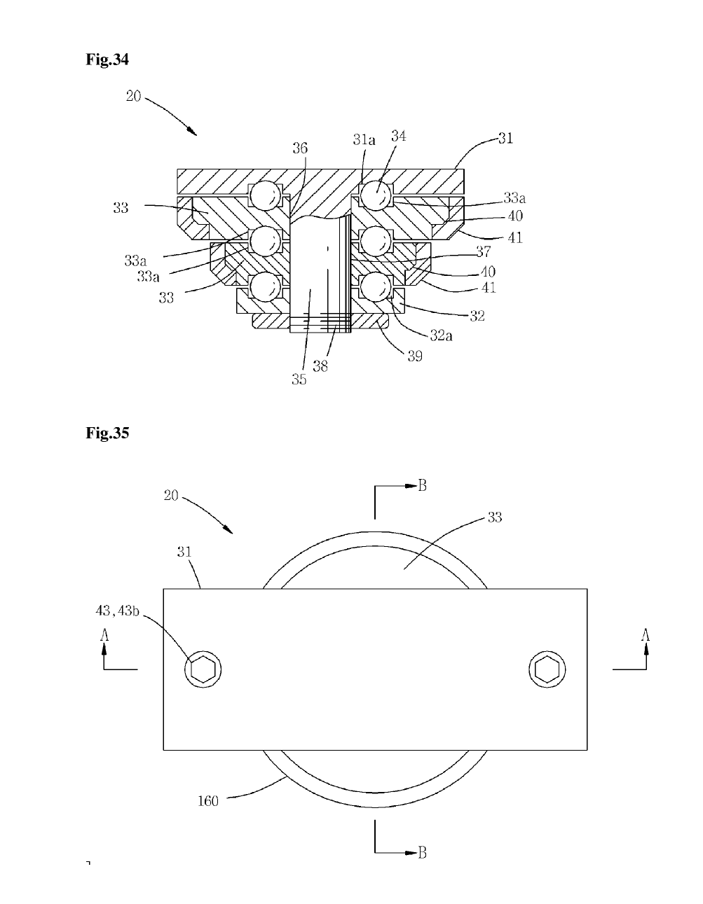

In the second exemplary embodiment of the lower door roller unit of the window and door system according to the present invention, a single wheel 33 may be coupled as illustrated in FIGS. 31 and 33, but a plurality of wheels 22 may be continuously coupled as illustrated in FIGS. 32 and 34

The plurality of wheels 22, which is continuously coupled as described above, may freely rotate independently of each other.

Meanwhile, a method in which the threaded portion 38 is formed on the end of the shaft 35 and the nut portion 39 is fastened to the threaded portion 38 may be adopted, but even when a key groove portion (not illustrated) is formed in the shaft 35, which penetrates the second through hole 37, and a key portion is tightly fitted into the key groove portion, the upper plate 31, the lower plate 32, and the wheel 33 may come into rolling contact with the plurality of balls 34, and maintain a secure coupled state, but these method may be variously presented, and the present invention is not limited thereto, but may be variously adopted and changed.

Meanwhile, as illustrated in FIGS. 31, 32, 33, and 34, a sliding portion 40 is formed on an outer diametric surface of the wheel 33, and the sliding portion 40 is formed as an inclined surface that is obliquely connected from any one of the upper surface or the lower surface of the wheel 33 to the outer diametric surface, or formed as a round surface having a bent or curved surface, thereby allowing the sliding portion 40 to come into rolling contact with and slide on a sliding surface of a rail, which will be described below.

In addition, in a case in which the sliding portion 40 directly comes into rolling contact with the sliding surface of the rail, abrasion or damage and noise due to friction may occur, and thus, an elastic sliding portion 41 is formed to be inserted into the outer diameter of the wheel 33 as illustrated in FIGS. 31, 32, 33, and 34, and as a result, in a case in which the elastic sliding portion 41 is damaged when used over a long period of time, the sliding portion 40 may be used like a new product by just replacing the corresponding elastic sliding portion 41, thereby achieving economic usage and convenient usage.

### Third Exemplary Embodiment

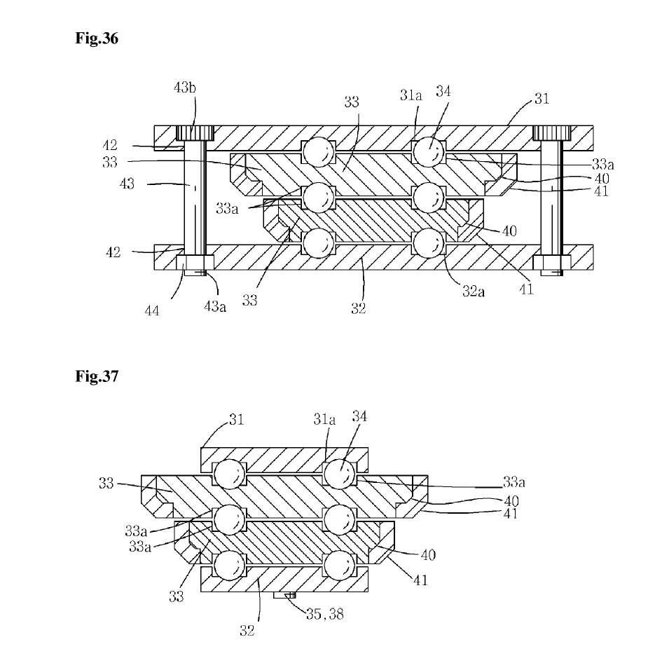

Because a third exemplary embodiment of the lower door roller 20 according to the present invention includes an upper plate 31, one or more wheels 33, a lower plate 32, and a plurality of balls 34, like the second exemplary embodiment, a detailed description thereof will be omitted, and because a coupling structure between the constituent elements as illustrated in FIGS. 35, 36, and 37 is differentiated from the second exemplary embodiment, only the coupling structure will be described.

That is, in the third exemplary embodiment, as illustrated in FIG. 35, a plurality of coupling holes 42 is formed in the upper and lower plate 31 and 32, and the plurality of coupling holes 42 is formed at a position within a region outside the outer diameters of the upper plate 31, the wheel 33, and the lower plate 32 from rotation centers of the upper plate 31, the wheel 33, and the lower plate 32

Further, regarding the coupling hole 42, a fixing member 43, which includes a head portion 43b that has an outer diameter greater than a diameter of the coupling hole 42, and a threaded portion 43a that may penetrate the coupling hole 42 and is formed by forming threads on an end thereof, is inserted into the coupling hole 42 of the upper plate 31 or the coupling hole 42 of the lower plate 32 so as to penetrate the coupling hole 42 of the lower plate 32 or the coupling hole 42 of the upper plate 31, and thereafter, the upper and lower plates 31 and 32 are tightened in a vertical direction by fastening a fastening member 44 to an end of the threaded portion 43a that penetrates the coupling hole 42, such that all or one or more wheels 33, which are coupled between the upper and lower plates 31 and 32, are fixed.

In this case, the plurality of balls 34 is inserted between the insertion grooves 31a and 32a of the upper and lower plates 31 and 32 and the insertion grooves 33a that are formed in the upper and lower surfaces of the wheel 33, and thus, the balls 34 are maintained in a state in which the balls 34 are fixed at inner circumferential surfaces of the insertion grooves 31a, 33a, and 32a in the horizontal direction, such that the wheels 33 may be prevented from moving in the horizontal direction, and come into rolling contact with the balls only in the rotation direction.

It is preferable that even in the third exemplary embodiment, a sliding portion 40 is formed on an outer diameter of the wheel 33, as described above, and an elastic sliding portion 41 is inserted into an outer diameter of the sliding portion 40

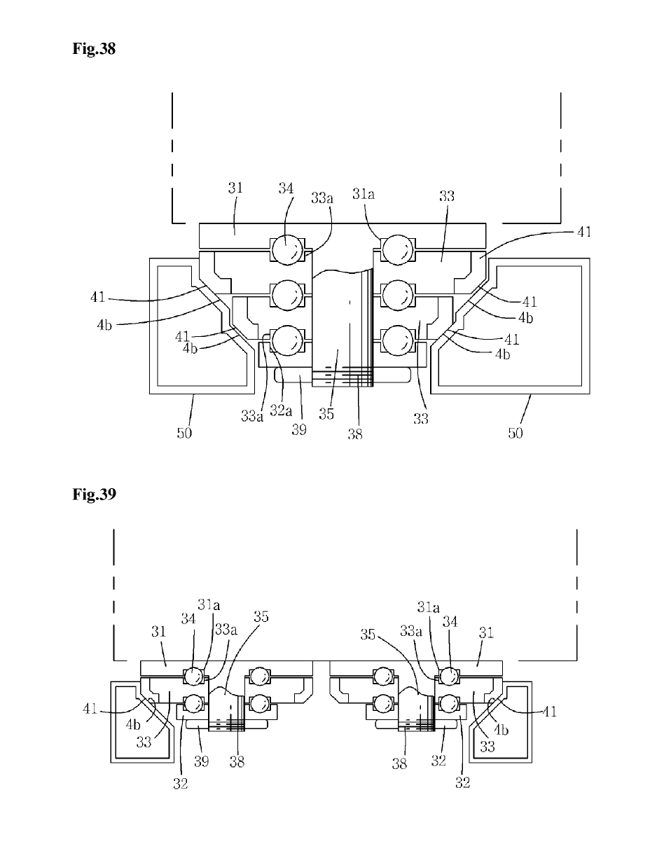

Meanwhile, in a case in which the wheel 33 of the first and second exemplary embodiments according to the present invention is installed in plural numbers, the wheels 33 having the same outer diameter may be installed, but even in a case in which the wheels 33 having different outer diameters are installed, there is no problem with an operational state in which the sliding portion 40 or the elastic sliding portion 41 of the wheel 33 and the sliding surface 212 of the rail slide while being in rolling contact with each other, and as illustrated in FIGS. 38 and 39, the aforementioned configurations may be made by changing and designing the structure of the rail of the present invention, and may be variously adopted and changed.

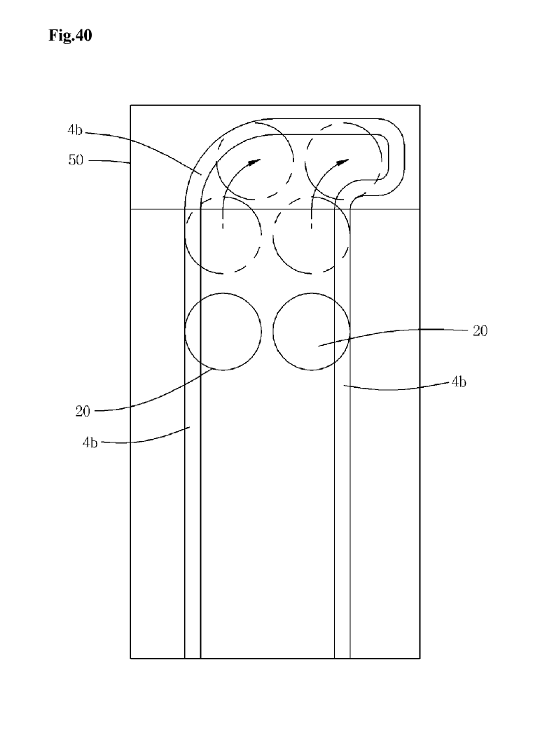

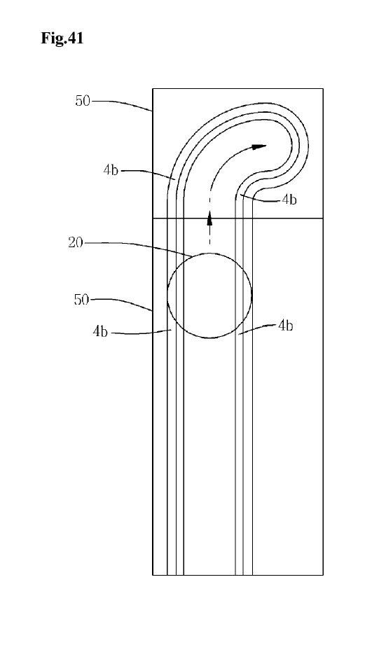

As illustrated in FIGS. 38 to 41, regarding the lower door roller 20 of the present invention, there are the case in which a single lower door roller 20 is used, and the case in which two lower door rollers 20 are used, and in both the cases, one side sliding portion 40 of the wheel 33 undergoes rolling contact, such that a load of the window frame, which is a heavy body, is applied to the wheel 33

In this case, when an eccentric load is applied to the wheel 33, an opposite side of the contact point is tilted downward by a vertical load of the window frame, and thereby, deflection of the window occurs as the opposite side is tilted.

Therefore, it is preferable that the outer diametric surface of the wheel 33 has contact points with a diagonal surface and a vertical surface of the guide 4 at the same time, or has a contact point with a diagonal surface or a rectilinear surface.

Here, in a case in which the wheel 33 has a contact point with only the diagonal surface, it is preferable that two or more wheels 33 are formed in layers.

However, as illustrated in FIGS. 32 and 34, the lower door roller 20 according to the present invention has been invented to support an eccentric load by allowing the lower plate 32 to maintain the rolling contact state with the lower portion of the wheel 33 using the balls 34, and allowing the upper plate 31 to also maintain the rolling contact state with the upper portion of the wheel 33 using the balls 34, such that the upper and lower plates 31 and 32 tighten and support the plurality of balls 34, which is installed together with the wheel 33 on the upper and lower portions of the wheel 33, and may minimize a gap or a clearance which is formed in the door roller 20 due to a load of the window frame.

Of course, even in the present invention, as described above, in order to basically block a clearance and a gap from being formed, as described above, it is preferable that a supporting portion 58 is extended to a lower end of the sliding portion 40 or the elastic sliding portion 41 of the wheel 33 such that the contact point is extended to the diagonal line and the vertical line.

### Fourth Exemplary Embodiment

A lower door roller unit 20 of a window and door system according to the present invention is installed on a lower end of a window frame, has a shaft 35 provided in the form of any one of a rectilinear shape or a diagonal shape, a bearing 26 is axially coupled to the shaft 35, and a rolling wheel 51, which has a diagonal contact surface formed on an outer diametric surface thereof, is coupled to an outer circumferential portion of the bearing 26, thereby smoothly rotating the rolling wheel 51

In addition, a catching and supporting portion 51a is formed on any one of upper and lower ends of the diagonal contact surface of the rolling wheel 51 so as to be extended at a predetermined angle in any one direction of upper and lower directions.

### Fifth Exemplary Embodiment

A lower door roller unit 20 of a window and door system according to the present invention has a diagonal contact surface formed on an outer diametric surface of a rolling wheel 51, and a shaft 55 integrally protrude upward from a rotation center of the rolling wheel 51

Further, a bearing 52 is coupled to the shaft 55, and a supporting portion 58 is extended from any one of upper and lower ends of the rolling wheel 51 at a predetermined angle in any one direction of upper and lower directions.

### Sixth Exemplary Embodiment

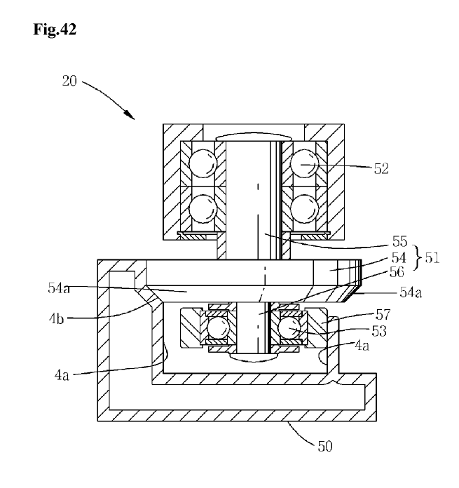

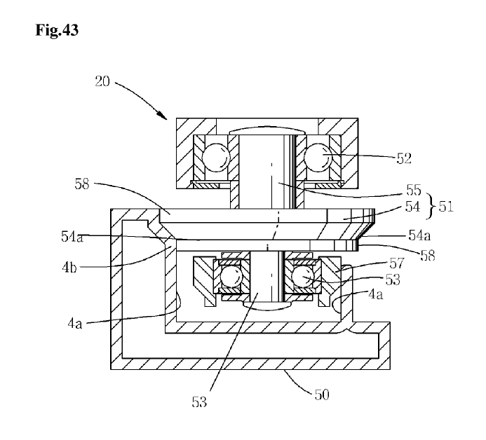

As illustrated in FIGS. 42 and 43, the rolling wheel 51 includes a wheel portion 54, an upper shaft 55, and a lower shaft 56, the wheel portion 54 is formed in a cylindrical shape having a predetermined height, and as illustrated in FIG. 42, an inclined surface 54a is formed at a lower end of an outer diametric surface, and has an outer diameter that gradually becomes small downward.

As illustrated, the upper shaft 55 and the lower shaft 56, which are rotation axes of a door roller 20, protrude on central portions of an upper surface and a lower surface of the wheel portion 54

Further, the upper bearing 52 is axially installed on an outer diameter of the upper shaft 55 so as to be rotatable, and the lower bearing 53 is axially installed on an outer diameter of the lower shaft 56 so as to be rotatable.

Here, because the coupling structure in which the upper bearing 52 and the lower bearing 53 are axially installed on the upper shaft 55 and the lower shaft 56 is a widely known and commonly used technology, a description of a specific coupling structure will be omitted in the present invention.

Here, the lower bearing 53 is formed to have an outer diameter smaller than an outer diameter of a lower end of the rolling wheel 51 (that is, an outer diameter of a lowermost end of the rolling wheel 51, which has an outer diameter that gradually becomes small as the inclined surface 54a is formed), and as illustrated in FIG. 37, the inclined surface 54a of the rolling wheel 51 may come into rolling contact with a diagonal guide 4b of a rail 50 of the present invention, and an outer diametric surface of the lower bearing 53 may come into close and rolling contact with an inner surface of a vertical portion 4a where a diagonal guide 4b is not formed, at an opposite side disposed to be spaced apart at a predetermined distance.

Further, it is preferable that a rotary ring 57 made of a soft material is coupled to and encloses or covers the outer diametric surface of any one of the rolling wheel 51 or the lower bearing 53, thereby minimizing frictional noise when the outer diametric surface undergoes rolling contact and slides.

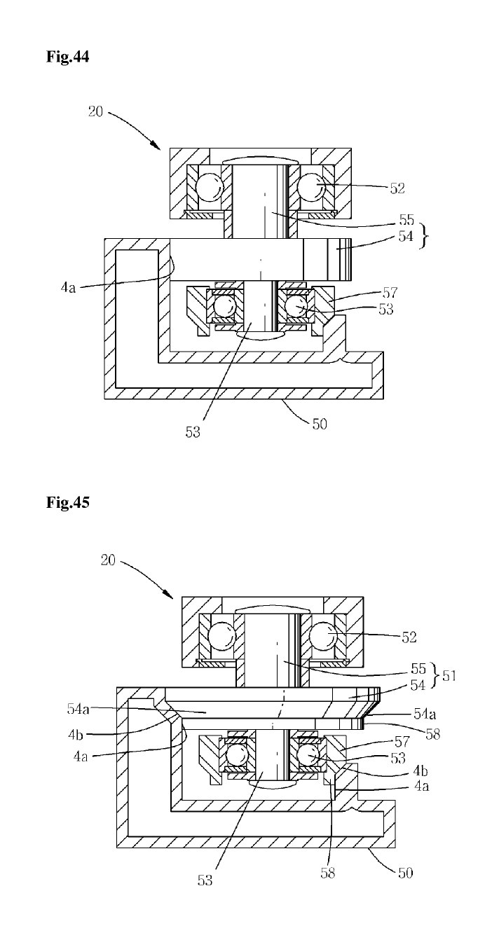

In addition, as illustrated in FIGS. 43 and 44, a supporting portion 58 is extended at a lower portion of the rolling wheel 51 or the rotary ring 57 in a vertical direction, and the supporting portion 58 comes into close and rolling contact with the vertical portion 4a of the lower portion of the guide 4, such that even though a load of the window frame is eccentrically applied to the upper bearing 52 in a case in which only the inclined surface 54a of one side of the rolling wheel 51 comes into rolling contact with the guide 4, the supporting portion 58 may prevent a clearance from being formed between the upper bearing 52 and the upper shaft 55 due to the eccentric load.

That is, an eccentrically sagging phenomenon due to a load of the window frame may be prevented, and the same effect may be obtained even in a case in which the upper bearing 52 is integrated with the rotation shaft.

In this case, as described above, the lower bearing 53 forms diagonal and rectilinear contact points, or a diagonal or rectilinear contact point.

### Seventh Exemplary Embodiment

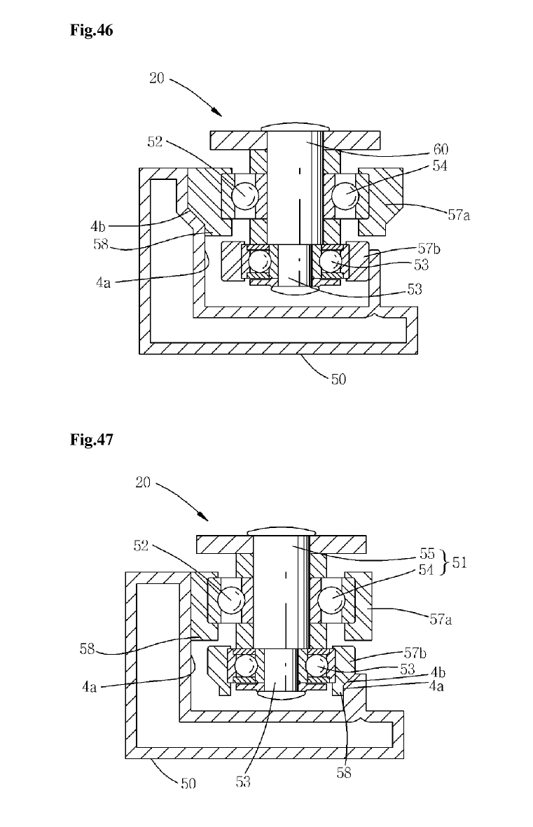

A lower door roller unit 20 of a window and door system according to the present invention has a shaft 60 formed in a cylindrical shape having a predetermined height, and as illustrated in FIG. 46, an upper bearing 52 is coupled to an upper outer diametric surface of the shaft 60 so as to be freely rotatable.

Further, as illustrated in FIG. 46, a lower bearing 53 is coupled to a lower outer diametric surface of the shaft 60, which is spaced apart from the upper bearing 52 downward at a predetermined distance, so as to be freely rotatable.

An upper rotary ring 57a, which corresponds to a shape of a guide 4, is coupled to an outer diameter of the upper bearing 52 so as to come into rolling contact with a diagonal guide 4b of the rail 50 which is obliquely formed, and as illustrated in FIG. 46, a lower portion of the upper rotary ring 57a has an inclined surface formed to have an outer diameter that gradually becomes small toward a lower end so as to correspond to an inclination angle of the diagonal guide 4b, such that the inclined surface may come into contact with the diagonal guide 4b

In addition, a supporting portion 58 is extended at a lower portion of the upper rotary ring 57a in a vertical direction, and the supporting portion 58 comes into close and rolling contact with a vertical portion 4a of a lower portion of the diagonal guide 4b, such that as described above, because the supporting portion 58 is supported on the vertical portion 4a, a clearance may be prevented from being formed between the shaft 60 and the upper bearing 52 even though a load of the window frame is eccentrically applied to the guide 4

Furthermore, it is preferable that a lower rotary ring 57b made of a soft material is also coupled to an outer diameter of the lower bearing 53, thereby minimizing frictional noise that occurs when the lower bearing 53 undergoes rolling contact.

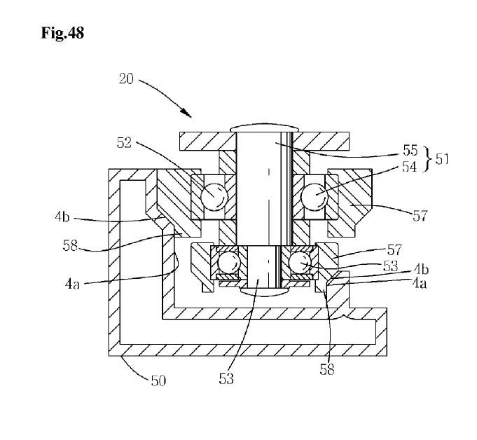

In the present invention, as illustrated in FIGS. 46 and 47, the diagonal guide 4b may come into rolling contact with any one of one side and the other side, and as illustrated in FIG. 48, the diagonal guide 4b may come into rolling contact with both the sides, such that the present invention may be carried out in various patterns regardless of the rolling contact point.

### Eighth Exemplary Embodiment

A lower door roller unit 20 of a window and door system according to the present invention has a plurality of bearings 26 that is coupled to a shaft 35, which is provided in the form of any one of a rectilinear shape or a diagonal shape, in upper and lower directions, and the bearings 26 are the bearings 26 that are configured in a row, or in a plurality of rows.

In addition, a rolling wheel 51, which has a diagonal contact surface formed on an outer diametric surface thereof, is coupled to the bearing 26 or an outer circumferential portion of the bearing 26, thereby smoothly rotating the rolling wheel 51

Further, another shaft 35 protrudes integrally or as a separate body downward at a center of the rolling wheel 51, the bearing 26 is also coupled to a lower end of the shaft 35, which protrudes downward, so as to be rotatable, and the rolling wheel 51 is coupled to an outer circumferential portion of the bearing 26

### Ninth Exemplary Embodiment

A lower door roller unit 20 of a window and door system according to the present invention has a structure in which a shaft 35 integrally protrudes upward at a rotation center of a rolling wheel 51, which has a diagonal surface or a diagonal contact surface formed on outer diametric surface thereof, a bearing 26 is axially coupled to the shaft 35, and the bearing 26 is coupled to a window frame, thereby smoothly rotating the shaft 35

In addition, a supporting portion 58 is formed on any one of upper and lower ends of the rolling wheel 51 so as to be extended at a predetermined angle in any one direction of upper and lower directions.

### Tenth Exemplary Embodiment

A wheel portion 54 formed in a cylindrical shape having a predetermined height is provided, an upper rolling wheel 51a, which has an upper shaft 55 and a lower shaft 56 integrally protrude at upper and lower ends of a central portion of the wheel portion 54, is provided, and a bearing 52 is axially coupled to an outer diameter of the upper shaft 55 so that the upper rolling wheel 51a and the upper shaft 55 rotate smoothly, thereby fixing the bearing 52 to a window frame.

Further, the bearing 52 is axially coupled so that the lower shaft 56 rotates smoothly, and a lower rolling wheel 51b, which comes into rolling contact with a guide 23 of a lower rail unit which is coupled to a window casing, is coupled to the bearing 52

In addition, a sliding portion 40 is formed as an inclined surface having a predetermined angle downward at a predetermined position of an outer diametric surface of any one of the upper rolling wheel 51a and the lower rolling wheel 51b

In addition, a supporting portion 58 is formed at an end of the sliding portion 40 of any one of the upper rolling wheel 51a and the lower rolling wheel 51b, which have the sliding portion 40, so as to be extended vertically or at a predetermined angle in any one direction of upper and lower directions.

### Eleventh Exemplary Embodiment

A wheel portion 54 formed in a cylindrical shape having a predetermined height is provided, a lower rolling wheel 51b, which has a shaft 35 that integrally protrude upward at a rotation center of the wheel portion 54, is provided, a bearing 26 is axially coupled to the shaft 35 so as to be freely rotatable, and an upper rolling wheel 51a is coupled to the bearing 26 so as to come into rolling contact with a guide 23 of a lower rail unit that is coupled to a window casing.

The bearing 26 is axially coupled to the shaft 35 positioned at an upper portion of the upper rolling wheel 51a, and fixed to a window so as to smoothly rotate the shaft 35.

In addition, a sliding portion 40 is formed at a predetermined position of an outer diametric surface of any one of the upper rolling wheel 51a and the lower rolling wheel 51b so as to have an inclined surface having predetermined angle in any one direction of upper and lower directions.

In addition, a supporting portion 58 is formed at any one of upper and lower ends of the sliding portion 40 having a diagonal surface, which is formed on any one of the upper and lower rolling wheels 51a and 51b, so as to be formed vertically or at a predetermined angle in any one direction of upper and lower directions.

Further, a rotary ring 57 made of a soft material is coupled to an outer diametric surface of any one of the upper rolling wheel 51a or the lower rolling wheel 51b

As described above, the upper rail unit, the upper door roller unit, the lower rail unit, and the lower door roller unit of the window and door system according to the present invention are progressive technologies that may be utilized for all the window and door systems, and may be applied to collapsible windows and doors, rotary doors, sliding doors, hinged doors, and the like.

In other words, the rail and the door roller move in a state in which the rail and the door roller come into close contact with each other such that the windows and the doors may be operated in a state in which vibration and rattling are remarkably reduced, and particularly, the rail unit and the door roller unit according to the present invention suggest mechanisms that may resolve problems with loads and vibration even in the case of hanger type windows and doors that do not slide smoothly and are not operated smoothly because of a load of the window frame, and thus, the present invention may be overall applied to all the industries where windows, doors, opening and closing doors, and the like are used.

The exemplary embodiments of the present invention have been described with reference to the accompanying drawings, but those skilled in the art will understand that the present invention may be implemented in any other specific form without changing the technical spirit or an essential feature thereof.

Accordingly, it will be understood that the aforementioned exemplary embodiments are described for illustration in all aspects and are not limited, and it will be construed that the scope of the present invention of the detailed description is represented by the claims to be described below, and all of the changes or modified forms induced from the meaning and the scope of the claims, and an equivalent concept thereof are included in the scope of the present invention.

### INDUSTRIAL APPLICABILITY

The present invention may be used to constitute a window and door system.

1. An upper rail unit of a window and door system, comprising:
one or more upper linear rail units 1 which are installed on an upper end of a window casing, are opened downward so as to rectilinearly guide a upper door roller 3 that is installed on an upper end of a window frame and has a vertical shaft 3a or a diagonal shaft 3b, have guides 4 that are vertically or diagonally formed at both sides thereof, and are rectilinearly formed to have a predetermined length; and
one or more upper meandering rail units 2 which diagonally or curvedly guide an upper door roller 3, which rectilinearly moves on the upper linear rail unit 1, so as to operate the window frame in a horizontal direction, are installed to be connected to one side end of the upper linear rail unit 1 so as to be connected to the guides 4 of the upper linear rail unit 1 with the same cross section, and have guides 4 that are diagonally or curvedly extended.

2. The upper rail unit of claim 1, wherein an interval between both the guides 4 of the meandering rail unit 2 is configured to have any one width among a predetermined narrow width, a predetermined wide width, and the same width so that the upper door roller 3 is guided based on a movement direction of the upper door roller 3.

3. An upper rail unit of a window and door system, comprising:
one or more upper linear rail units 1 which are installed on an upper end of a window casing, are opened downward so as to rectilinearly guide an upper door roller 3 that is installed on an upper end of a window frame, have guides 4 that are diagonally or rectilinearly formed at both sides thereof, and are rectilinearly formed to have a predetermined length; and
an upper meandering rail unit 2 which diagonally or curvedly guides the upper door roller 3, which rectilinearly moves on the upper linear rail unit 1, so as to operate the window frame in a horizontal direction, is installed to be connected to one side end of the upper linear rail unit 1 so as to be connected to the upper linear rail unit 1 with the same cross section, and includes a plurality of protruding portions 13 that protrudes at a predetermined position of one side surface of any one of both the guides 4 so as to guide the upper door roller 3 toward the other side surface, and a groove portion 14 that is formed in an inner surface of the other guide 4 so that the upper door roller 3, which comes into rolling contact with the guide 4 and moves, is inserted into the groove portion 14 by the protruding portion 13 when the upper door roller 3 is guided toward the other side surface.

4. An upper rail unit of a window and door system, comprising:
one or more linear rail units 1 which are installed on an upper end of a window casing, protrude downward so as to rectilinearly guide an upper door roller 3 that is installed on an upper end of a window frame, have guides 4 that are formed on both vertical side surfaces thereof so as to have contact points with the upper door roller and guide the upper door roller, and are rectilinearly formed to have a predetermined length; and
an upper meandering rail unit 2 which is installed to be connected to the upper linear rail unit 1 so as to operate the window frame in a horizontal direction while diagonally or curvedly guiding the upper door roller 3 that comes into contact with both vertical side surfaces of the upper linear rail unit 1 and rectilinearly moves, has guides 4 that protrude downward and are formed on both vertical side surfaces so as to have contact points with the upper door roller 3 and guide the upper door roller 3, and is diagonally or curvedly extended.

5. The upper rail unit of claim 4, wherein the upper meandering rail unit 2 is extended with different starting positions at a curved line or a diagonal line on both side surfaces of the guide 4 of the upper meandering rail unit 2 so that any one upper door roller 3, which comes into rolling contact with any one of both the side surfaces of the guide 4 of the upper meandering rail unit 2, moves at a distance longer than a rectilinear movement distance of the other upper door roller 3 when a direction of the upper door roller 3 is converted into a curved or diagonal direction, and a guide groove 4c is formed in any one of both the side surfaces of the guide 4 having a diagonal or curved surface, which is a diagonal or curved surface of the guide 4 of the upper meandering rail unit 2, so that the upper door roller 3 meanderingly moves and comes into rolling contact with both the side surfaces of the guide 4 of the upper meandering rail unit 2 which has a diagonal or curved surface.

6. An upper door roller unit of a window and door system, which is installed on an upper end of a window frame, and has two or more rollers 3d and 3e provided on a single vertical shaft 3a or a single diagonal shaft 3b, wherein when the rollers 3d and 3e move on the upper linear rail unit 1 and the upper meandering rail unit 2 of claim 1, the rollers 3d and 3e rotate in the directions opposite to each other in a state in which the rollers 3d and 3e maintain rolling contact points with different guides 4a and 4b.

7. An upper door roller unit of a window and door system, which is installed on an upper end of a window frame, and has rollers 3e provided on two or more shafts 3a and 3b having a diagonal or vertical shape, wherein when the respective rollers 3e move on the upper linear rail unit 1 and the upper meandering rail unit 2 of claim 1, the rollers 3e rotate in the directions opposite to each other in a state in which the rollers 3 maintain rolling contact points with a vertical guide 4a or a diagonal guide 4b, respectively.

8. The upper door roller unit of claim 7, wherein the shafts 3a and 3b are laterally spaced apart from each other at a predetermined distance so that the rollers 3e do not interfere with each other.

9. An upper door roller unit of a window and door system, which is installed on an upper end of a window frame, and is installed in plural numbers, such that a plurality of upper door rollers 3 is spaced apart from each other in one side rectilinear line at a predetermined distance, one or more upper door rollers 3 are installed at the other side between the plurality of upper door rollers 3, and when the upper door roller 3 at the one side is guided toward the other side by a protruding portion 13, the upper door roller 3 at the other side is inserted into a groove portion 14.

10. A lower rail unit of a window and door system, comprising:
a lower linear rail unit 21 which is installed on a lower end of a window casing, and opened upward so as to rectilinearly guide a plurality of lower door rollers 20 which is installed on a lower end of a window frame and has a vertical shaft 3a or a diagonal shaft 3b;
a lower meandering rail unit 22 which is opened upward so as to be connected to the lower linear rail unit 21 with the same cross section, and installed to be connected to one side end of the lower linear rail unit 21, and diagonally or curvedly formed so as to diagonally or curvedly guide the door roller 20; and
guides 23 which are installed integrally or as separate bodies on both side surfaces in the lower linear rail unit 21 and the lower meandering rail unit 22, and form rolling contact points with the plurality of lower door rollers 20 so as to allow the plurality of lower door rollers 20 to slide.

11. The lower rail unit of claim 10, wherein an interval between both the guides 23 of the meandering rail unit 22 is configured to have any one width among a predetermined narrow width, a predetermined wide width, and the same width so that the lower door roller 20 is guided based on a movement direction of the lower door roller 20.

12. The lower rail unit of claim 10, wherein any one of the guides 23 is a diagonal guide 23a which is diagonally formed so that a contact point with the door roller 20 is formed at a diagonal surface, or a vertical guide 23b which is vertically formed so that a contact point with the door roller 20 is formed at a vertical surface.

13. The lower rail unit of claim 12, wherein a catching guide 23c is extended on any one of upper and lower ends of the diagonal guide 23a at a predetermined angle in any one direction of upper and lower directions such that the lower door roller 20 comes into rolling contact with the diagonal guide 23a and the catching guide 23c at the same time and slides.

14. The lower rail unit of claim 11, wherein the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20.

15. The lower rail unit of claim 11, wherein any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

16. The lower rail unit of claim 11, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

17. The lower rail unit of claim 11, wherein a plurality of guide grooves 24 is formed in any one of the diagonal guide 23a and the vertical guide 23b so as to be spaced apart from each other at a predetermined interval, and formed in a longitudinal direction, protruding guides 25, which are foamed to have a circular or polygonal cross section and integrally and continuously formed in a longitudinal direction, are inserted into and fixed to the guide grooves 24, and one side surface of the protruding guides 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

18. A lower rail unit of a window and door system, comprising:
one or more lower linear rail units 21 which are installed on a lower end of a window casing, are opened upward so as to rectilinearly guide a lower door roller 20 that is installed on a lower end of a window frame, have guides 23 that are diagonally or rectilinearly formed at both sides thereof, and are rectilinearly formed to have a predetermined length; and
a lower meandering rail unit 22 which diagonally or curvedly guides the lower door roller 20, which rectilinearly moves on the lower linear rail unit 21, so as to operate the window frame in a horizontal direction, is installed to be connected to one side end of the lower linear rail unit 21 so as to be connected to the lower linear rail unit 21 with the same cross section, and includes a plurality of protruding portions 13 that protrudes at a predetermined position of one side surface of any one of both the guides 23 so as to guide the lower door roller 21 toward the other side surface, and a groove portion 14 that is formed in an inner surface of the other guide 23 so that the lower door roller 21, which comes into rolling contact with the guide 23 and moves, is inserted into the groove portion 14 by the protruding portion 13 when the lower door roller 21 is guided toward the other side surface.

19. The lower rail unit of claim 18, wherein any one of the guides 23 is a diagonal guide 23a which is diagonally formed so that a contact point with the lower door roller 20 is formed at a diagonal surface, or a vertical guide 23b which is vertically formed so that a contact point with the door roller 20 is formed at a vertical surface.

20. The lower rail unit of claim 19, further comprising:
a catching guide 23c which is extended from any one of upper and lower ends of the diagonal guide 23a at a predetermined angle in any one direction of upper and lower directions.

21. The lower rail unit of claim 19, wherein the guides 23 are configured as one set of the diagonal guide 23a, which is diagonally fanned so that a contact point is formed at the diagonal surface, and the vertical guide 23b, which is vertically formed so that a contact point is formed at the vertical surface, or are configured as one set of the diagonal guide 23a and the diagonal guide 23a.

22. The lower rail unit of claim 18, wherein any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

23. The lower rail unit of claim 18, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

24. The lower rail unit of claim 18, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

25. A lower rail unit of a window and door system, comprising:
one or more lower linear rail units 21 which are installed on a lower end of a window casing, protrude upward so as to rectilinearly guide a lower door roller 20, which is installed on a lower end of a window frame and has a vertical shaft 21a or a diagonal shaft 21b, while coming into rolling contact with the lower door roller 20, are rectilinearly formed to have a predetermined length, and have guides 23 that are formed to have a vertical surface or a diagonal surface formed at both sides thereof; and
a lower meandering rail unit 22 which diagonally or curvedly guides the lower door roller 20, which rectilinearly moves on the lower linear rail unit 21, so as to operate a window frame in a horizontal direction, is installed to be connected to the lower linear rail unit 21 so as to be connected to the lower linear rail unit 21 with the same cross section, and has guides 23, which are diagonally or curvedly extended, and a rectilinear portion 22a that is rectilinearly formed to have a predetermined length and extended.

26. The lower rail unit of claim 25, wherein the lower meandering rail unit 22 is extended with different starting positions at a curved line or a diagonal line on both side surfaces of the guide 23 of the lower meandering rail unit 22 so that any one lower door roller 20, which comes into rolling contact with any one side surface of the guide 23 of the lower meandering rail unit 22, moves at a distance longer than a rectilinear movement distance of the other lower door roller 20 when a direction of the lower door roller 20 is converted into a curved or diagonal direction, and a guide groove 24 is formed in any one of inner and outer surfaces of the diagonal surface or the curved surface, which is a diagonal or curved surface of the guide 23 of the lower meandering rail unit 22, so that the lower door roller 20 meanderingly moves and comes into rolling contact with the inner and outer surfaces of the diagonal or curved surface of the guide 23 of the lower meandering rail unit 22.

27. The lower rail unit of claim 25, wherein any one side surface of the guide 23 is a diagonal guide 23a which is diagonally formed so that a contact point with the door roller 20 is formed at a diagonal surface, or a vertical guide 23b which is vertically formed so that a contact point with the door roller 20 is formed at a vertical surface.

28. The lower rail unit of claim 27, wherein a catching guide 23c is extended on any one of upper and lower ends of the diagonal guide 23a at a predetermined angle in any one direction of upper and lower directions such that the lower door roller 20 comes into rolling contact with the diagonal guide 23a and the catching guide 23c at the same time and slides.

29. The lower rail unit of claim 26, wherein the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20.

30. The lower rail unit of claim 26, wherein any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

31. The lower rail unit of claim 26, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

32. The lower rail unit of claim 26, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes outward from the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

33. A lower door roller unit of a window and door system, comprising:
a shaft 35 which is installed on a lower end of a window frame, and provided in the form of any one of a rectilinear shape and a diagonal shape;
a bearing 26 which is axially coupled to the shaft 35;
a rolling wheel 51 which is coupled to enclose an outer circumferential portion of the bearing 26, and has a diagonal contact surface formed on an outer diametric surface thereof; and
a catching and supporting portion 51a which is formed on any one of upper and lower ends of the diagonal contact surface of the rolling wheel 51 so as to be extended at a predetermined angle in any one direction of upper and lower directions.

34. A lower door roller unit of a window and door system, comprising:
a shaft 35 which is installed on a lower end of a window frame, and provided in the form of any one of a rectilinear shape and a diagonal shape;
two or more bearings 26 which are configured in a row or in a plurality of rows and axially coupled to the shaft 35 in upper and lower directions; and
a rolling wheel 51 which is coupled to enclose the bearing 26 or an outer circumferential portion of the bearing 26, and has a diagonal contact surface formed on an outer diametric surface thereof.

35. The lower door roller unit of claim 33, wherein another shaft 35 protrudes integrally or as a separate body downward at a center of the rolling wheel 51, and the bearing 26 or the rolling wheel 51 is coupled to a lower end of the shaft 35, which protrudes downward, so as to be rotatable.

36. A lower door roller unit of a window and door system, comprising:
a rolling wheel 51 which is installed on a lower end of a window frame, and has an outer diametric surface that is diagonally formed;
a shaft 35 which integrally protrudes upward at a rotation center of the rolling wheel 51; and
a bearing 26 which is coupled to the shaft 35 and the window frame.

37. The lower door roller unit of claim 36, comprising:
a supporting portion 58 which is formed on any one of upper and lower ends of the rolling wheel 51 so as to be extended at a predetermined angle in any one direction of upper and lower directions.

38. A lower door roller unit of a window and door system, comprising:
a wheel portion 54 which is formed in a cylindrical shape having a predetermined height;
an upper rolling wheel 51a which has an upper shaft 55 and a lower shaft 56 that integrally protrude at upper and lower ends of a central portion of the wheel portion 54;
an upper bearing 52 which is axially coupled to an outer diameter of the upper shaft 55 and fixed to a window frame so that the upper rolling wheel 51a and the upper shaft 55 rotate smoothly; and
a lower rolling wheel 51b which comes into rolling contact with a guide 23 of a lower rail unit coupled to a window casing so that the lower shaft 56 rotates smoothly.

39. The lower door roller unit of claim 38, comprising:
a sliding portion 40 which is formed as an inclined surface having a predetermined angle downward at a predetermined position of an outer diametric surface of any one of the upper rolling wheel 51a and the lower rolling wheel 51b.

40. The lower door roller unit of claim 39, further comprising:
a supporting portion 58 which is formed at an end of the sliding portion 40 of any one of the upper rolling wheel 51a and the lower rolling wheel 51b, which have the sliding portion 40, so as to be extended vertically or at a predetermined angle in any one direction of upper and lower directions.

41. A lower door roller unit of a window and door system, comprising:
a wheel portion 54 which is formed in a cylindrical shape having a predetermined height;
a lower rolling wheel 51b which has a shaft 35 that integrally protrudes upward at a rotation center of the wheel portion 54;
an upper rolling wheel 51a which is axially coupled to the shaft 35 so as to be freely rotatable, and comes into rolling contact with a guide 23 of a lower rail unit coupled to a window casing; and
a bearing 26 which is axially coupled to the shaft 35 at a position of an upper portion of the upper rolling wheel 51a, and fixed to a window so as to smoothly rotate the shaft 35.

42. The lower door roller unit of claim 41, comprising:
a sliding portion 40 which is formed as an inclined surface having a predetermined angle in any one direction of upper and lower directions at a predetermined position of an outer diametric surface of any one of the upper rolling wheel 51a and the lower rolling wheel 51b.

43. The lower door roller unit of claim 42, further comprising:
a supporting portion 58 which is formed at any one of upper and lower ends of the sliding portion 40 having a diagonal surface, which is formed on any one of the upper and lower rolling wheels 51a and 51b so as to be extended vertically or at a predetermined angle in any one direction of upper and lower directions.

44. The lower door roller unit of claim 42, comprising:
a rotary ring 57 which is made of a soft material and coupled to an outer diametric surface of any one of the upper rolling wheel 51a and the lower rolling wheel 51b.

45. The lower rail unit of claim 12, wherein the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20.

46. The lower rail unit of claim 12, wherein any one of the diagonal guide 23a and the vertical guide 23b of the guides 23, which are integrally foamed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

47. The lower rail unit of claim 13, wherein any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

48. The lower rail unit of claim 12, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

49. The lower rail unit of claim 13, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

50. The lower rail unit of claim 12, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guides 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

51. The lower rail unit of claim 13, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guides 25 partially protrudes into the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

52. The lower rail unit of claim 27, wherein the guides 23 are one set of a diagonal guide 23a, which is diagonally formed so that a contact point is formed at a diagonal surface, and a vertical guide 23b, which is vertically formed so that a contact point is formed at a vertical surface, or one set of the diagonal guide 23a and the diagonal guide 23a, and any one of the diagonal guide 23a and the vertical guide 23b is formed to be longer than the other vertical guide 23b or the other diagonal guide 23a so as to relatively increase a movement distance of the lower door roller 20.

53. The lower rail unit of claim 28, wherein any one of the diagonal guide 23a and the vertical guide 23b of the guides 23, which are integrally formed so as to be integrally extended and installed to the lower linear rail unit 21 and the lower meandering rail unit 22, is integrally assembled with or attached to the lower linear rail unit 21 and the lower meandering rail unit 22 so that a connection region between the lower linear rail unit 21 and the lower meandering rail unit 22 is continuous without being disconnected.

54. The lower rail unit of claim 27, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

55. The lower rail unit of claim 28, wherein in a case in which the diagonal guide 23a and the vertical guide 23b or the diagonal guide 23a and the diagonal guide 23a are formed and assembled as one set, the diagonal guide 23a and the vertical guide 23b or the diagonal guide 23a and the diagonal guide 23a are installed to have the same height, or any one thereof is installed to be relatively high.

56. The lower rail unit of claim 27, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes outward from the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

57. The lower rail unit of claim 28, wherein a plurality of guide grooves 24 is formed in any one of the diagonal guide 23a and the vertical guide 23b so as to be spaced apart from each other at a predetermined interval, and formed in a longitudinal direction, protruding guides 25, which are formed to have a circular or polygonal cross section and integrally and continuously formed in a longitudinal direction, are inserted into and fixed to the guide grooves 24, and one side surface of the protruding guide 25 partially protrudes outward from the lower linear rail unit 21 and the lower meandering rail unit 22 so as to form the diagonal guide 23a or the vertical guide 23b that is continuous without being disconnected such that a contact point with the lower door roller 20 is formed in the form of a line or a surface.

58. The lower door roller unit of claim 43, comprising:
a rotary ring 57 which is made of a soft material and coupled to an outer diametric surface of any one of the upper rolling wheel 51a and the lower rolling wheel 51b.
